(19) United States
(12) Patent Application Publication
(10) Pub. No.: US 2026/0289329 A1
(43) Pub. Date: Sep. 24, 2026

(54) SYSTEM

(71) Applicant: SoftBank Group Corp., Tokyo (JP)

(72) Inventor: Yasuhiro MIZUSHIMA, Tokyo (JP)

(73) Assignee: SoftBank Group Corp., Tokyo (JP)

(21) Appl. No.: 19/567,328

(22) Filed: Mar. 16, 2026

(30) Foreign Application Priority Data
Mar. 19, 2025 (JP) 2025-045279

(51) Int. Cl. G06N 5/01; G06F 40/205; G06F 40/284; G06F 40/295; G06F 40/40; G06N 3/0475; G06V 10/764; G06V 10/82; G06V 20/70; G10L 25/24

(52) U.S. Cl. CPC G06N 5/01; G06F 40/205; G06F 40/284; G06F 40/295; G06F 40/40; G06N 3/0475; G06V 10/764; G06V 10/82; G06V 20/70; G10L 25/24

(57) ABSTRACT

A system includes a processor configured to acquire user information including ingredients, required cooking time, preferences, and number of people. The processor analyzes the information using natural language processing and generates a prompt for a generative AI model to recognize a user emotion. Based on the emotion analysis and the acquired information, the generative AI model proposes candidate dishes. For a dish selected by the user, the processor generates a video link indicating a cooking procedure and produces a summarized cooking procedure using natural language processing. The processor further searches for dining facilities or delivery services that provide the selected dish and provides information to support ordering of the dish.

### CROSS-REFERENCE TO RELATED APPLICATION

This application is based on and claims priority under 35 USC 119 from Japanese Patent Application No. 2025-045279 filed on Mar. 19, 2025, the disclosure of which is incorporated by reference herein.

### BACKGROUND

### Technical Field

The present disclosure relates to a system.

### Related Art

Japanese Patent Application Laid-Open (JP-A) No. 2022-180282 discloses a persona chatbot control method executed by at least one processor. The method includes steps of: receiving a user utterance, adding the user utterance to a prompt including a description of a chatbot character and an associated instruction sentence, encoding the prompt, and inputting the encoded prompt to a language model to generate a chatbot utterance responding to the user utterance.

Conventional recipe recommendation systems typically propose dishes based on explicit user inputs such as available ingredients, desired cooking time, and general preferences, without sufficiently considering the user's emotional state or nuanced preferences at the time of use. As a result, such systems often fail to provide candidate dishes that are truly aligned with the user's current mood or emotional needs, which may reduce user satisfaction and engagement. Furthermore, conventional systems generally do not provide an integrated mechanism that, in a single workflow, both guides the user in cooking a selected dish and supports ordering the same or similar dish from dining facilities or delivery services when the user prefers not to cook. In addition, existing systems often lack an efficient way to automatically generate concise, user-friendly cooking instructions and associated video links tailored to the selected dish. Therefore, there is a need for a system that can recognize a user's emotion by leveraging generative AI models and natural language processing, propose optimized candidate dishes that match both the user's explicit preferences and emotional state, and seamlessly support either cooking the selected dish or ordering it from external services.

### SUMMARY

In order to solve the above-described problems, a system according to one embodiment comprises a processor configured to acquire, via an interface for receiving information from a user, information including ingredients, required cooking time, user preferences, and number of people. The processor is configured to analyze the acquired information by using natural language processing techniques and to generate a prompt for instructing a generative AI model to recognize an emotion of the user. The processor is further configured to input the generated prompt into the generative AI model, analyze the emotion of the user based on an output of the generative AI model, and, based on an emotion analysis result together with the information acquired from the user, propose a plurality of candidate dishes by using the generative AI model. The processor is configured to optimize the plurality of candidate dishes based on the emotion analysis result and to select one or more dishes that match a preference of the user. The processor is also configured to generate a video link indicating a cooking procedure for a dish selected by the user and to generate a summarized version of the cooking procedure by using natural language processing techniques, and to provide the video link and the summarized cooking procedure to the user. In addition, the processor is configured to search for a dining facility or a delivery service that provides the dish selected by the user, to provide information for supporting ordering of the dish, and to provide an interface that enables the user to place an order to the dining facility or delivery service.

The term “processor” refers to one or more hardware computing units, such as a central processing unit (CPU), graphics processing unit (GPU), application specific integrated circuit (ASIC), or system-on-chip (SoC), configured to execute instructions and perform the functions described in the claims.

The term “interface” refers to a hardware and/or software component that enables exchange of information between the user and the system, including, for example, graphical user interfaces, web pages, mobile application screens, voice input interfaces, or APIs that receive and output user-related data.

The term “information including ingredients, required cooking time, user preferences, and number of people” refers to data provided directly or indirectly by the user that indicates food items or materials available for cooking, a time constraint or limit for preparing a dish, desired characteristics of dishes such as cuisine type or dietary restrictions, and a count of persons who will consume the dish.

The term “natural language processing techniques” refers to algorithms, models, or software functions that analyze, interpret, generate, or transform human language text or speech, including but not limited to tokenization, parsing, sentiment analysis, summarization, and text generation.

The term “prompt” refers to a text or structured input sequence generated by the processor and supplied to a generative AI model in order to request the model to perform a specific task, such as recognizing a user emotion or proposing candidate dishes.

The term “generative AI model” refers to a machine learning model capable of generating text or other content in response to input data, including, for example, large language models, transformer-based models, or similar models trained to produce natural language outputs.

The term “emotion of the user” refers to a mental or affective state of the user, such as happiness, sadness, stress, relaxation, excitement, or similar emotional conditions, inferred from user-provided information or interactions.

The term “emotion analysis result” refers to data representing the outcome of processing by the generative AI model or other analysis modules that indicates one or more inferred emotions or emotional tendencies of the user.

The term “candidate dishes” refers to one or more dish options, recipes, or meal concepts proposed by the system as possible choices for the user, based on the user's information and the emotion analysis result.

The term “optimize the plurality of candidate dishes” refers to adjusting, filtering, ranking, or refining the set of proposed candidate dishes by taking into account the emotion analysis result and other user-related parameters so as to better match the user's preferences and emotional state.

The term “video link” refers to an electronic address such as a URL or URI that, when accessed by a terminal, causes a video corresponding to a cooking procedure for a selected dish to be played or made available.

The term “cooking procedure” refers to a sequence of actions, operations, or instructions that describe how to prepare and cook a dish, including ingredient preparation, cooking steps, and finishing steps.

The term “summarized version of the cooking procedure” refers to a concise, shortened, or simplified representation of the full cooking procedure, generated by the system so that the user can quickly understand the main steps required to prepare the dish.

The term “dining facility” refers to an establishment that prepares and serves food or meals to customers, such as a restaurant, café, cafeteria, or similar venue.

The term “delivery service” refers to a service that transports prepared food from a dining facility or kitchen to a user-specified location, including services provided directly by a restaurant or by a third-party delivery platform.

The term “information for supporting ordering of the dish” refers to data presented to the user that assists in placing an order for the selected dish, including, for example, names and locations of dining facilities, menu information, pricing, availability, and links or controls for initiating an order.

The term “interface that enables ordering of the dish” refers to a hardware and/or software component that presents order-related options to the user and accepts order-related inputs, such as item selection, quantity, delivery address, and payment information, to cause an order to be placed with a dining facility or delivery service.

### BRIEF DESCRIPTION OF THE DRAWINGS

Exemplary embodiments of the present disclosure will be described in detail based on the following figures, wherein:

FIG. 1 is a schematic diagram illustrating an example of a configuration of a data processing system according to a first exemplary embodiment;

FIG. 2 is a schematic diagram illustrating an example of relevant functions of a data processing device and a smart device according to the first exemplary embodiment;

FIG. 3 is a schematic diagram illustrating an example of a configuration of a data processing system according to a second exemplary embodiment;

FIG. 4 is a schematic diagram illustrating an example of relevant functions of a data processing device and smart glasses according to the second exemplary embodiment;

FIG. 5 is a schematic diagram illustrating an example of a configuration of a data processing system according to a third exemplary embodiment;

FIG. 6 is a schematic diagram illustrating an example of relevant functions of a data processing device and a headset-type terminal according to the third exemplary embodiment;

FIG. 7 is a schematic diagram illustrating an example of a configuration of a data processing system according to a fourth exemplary embodiment;

FIG. 8 is a schematic diagram illustrating an example of relevant functions of a data processing device and a robot according to the fourth exemplary embodiment;

FIG. 9 illustrates an emotion map mapping plural emotions;

FIG. 10 illustrates an emotion map mapping plural emotions;

FIG. 11 is a sequence diagram showing the flow of data processing system processing in Example 1;

FIG. 12 is a sequence diagram showing the flow of data processing system processing in Application Example 1;

FIG. 13 is a sequence diagram showing the flow of data processing system processing in Example 2; and

FIG. 14 is a sequence diagram showing the flow of data processing system processing in Application Example 2.

### DETAILED DESCRIPTION

Description follows regarding an example of exemplary embodiments of a system according to technology disclosed herein, with reference to the appended drawings.

First, explanation follows regarding terminology employed in the following description.

In the following exemplary embodiments, a reference-numeral-appended processor (hereinafter simply referred to as “processor”) may be implemented by a single computation unit, and may be implemented by a combination of plural computation units. The processor may be implemented by a single type of computation unit, or may be implemented by a combination of plural types of computation units. Examples of computation unit include a central processing unit (CPU), a graphics processing unit (GPU), a general-purpose computing on graphics processing units (GPGPU), an accelerated processing unit (APU), and the like.

In the following exemplary embodiments, random access memory (RAM) appended with a reference numeral is memory temporarily stored with information, and is employed as working memory by a processor.

In the following exemplary embodiments, reference-numeral-appended storage is a single or plural non-volatile storage devices for storing various programs and various parameters and the like. Examples of non-volatile storage devices include flash memory (such as a solid state drive (SSD)), a magnetic disk (for example, a hard disk), magnetic tape, and the like.

In the following exemplary embodiments, a reference-numeral-appended communication interface (I/F) is an interface including a communication processor and an antenna or the like. The communication I/F has the role of communicating between plural computers. An example of a communication standard applied for the communication I/F is a wireless communication standard, such as a Fifth Generation Mobile Communication System (5G), Wi-Fi (registered trademark), Bluetooth (registered trademark), and the like.

In the following exemplary embodiments “A and/or B” has the same definition as “at least one out of A or B”. Namely, “A and/or B” may mean A alone, may mean B alone, or may mean a combination of A and B. Moreover, similar logic to “A and/or B” is applied when “and/or” is employed to link three or more items in the present specification.

### First Exemplary Embodiment

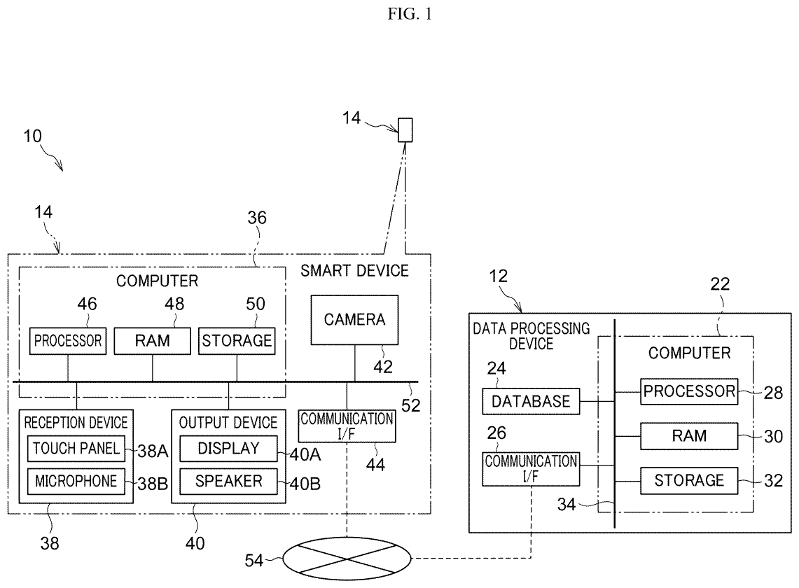

FIG. 1 illustrates an example of a configuration of a data processing system 10 according to a first exemplary embodiment.

As illustrated in FIG. 1, the data processing system 10 includes a data processing device 12 and a smart device 14. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The smart device 14 includes a computer 36, a reception device 38, an output device 40, a camera 42, and a communication I/F 44. The computer 36 includes a processor 46, RAM 48, and storage 50. The processor 46, the RAM 48, and the storage 50 are connected to a bus 52. The reception device 38, the output device 40, the camera 42, and the communication I/F 44 are also connected to the bus 52.

The reception device 38 includes a touch panel 38A, a microphone 38B, and the like for receiving user input. The touch panel 38A receives user input from contact of a pointer (for example, a pen, a finger, or the like) by detecting contact of the pointer. The microphone 38B receives spoken user input by detecting speech of the user. A control unit 46A in the processor 46 transmits data representing the user input received by the touch panel 38A and the microphone 38B to the data processing device 12. A specific processing unit 290 in the data processing device 12 acquires the data indicating the user input.

The output device 40 includes a display 40A, a speaker 40B, and the like for presenting data to a user 20 by outputting the data in an expression format perceivable by the user 20 (for example, audio and/or text). The display 40A displays visual information such as text, images, or the like under instruction from the processor 46. The speaker 40B outputs audio under instruction from the processor 46. The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like.

The communication I/F 44 is connected to the network 54. The communication I/F 44 and the communication I/F 26 perform the role of exchanging various information between the processor 46 and the processor 28 over the network 54.

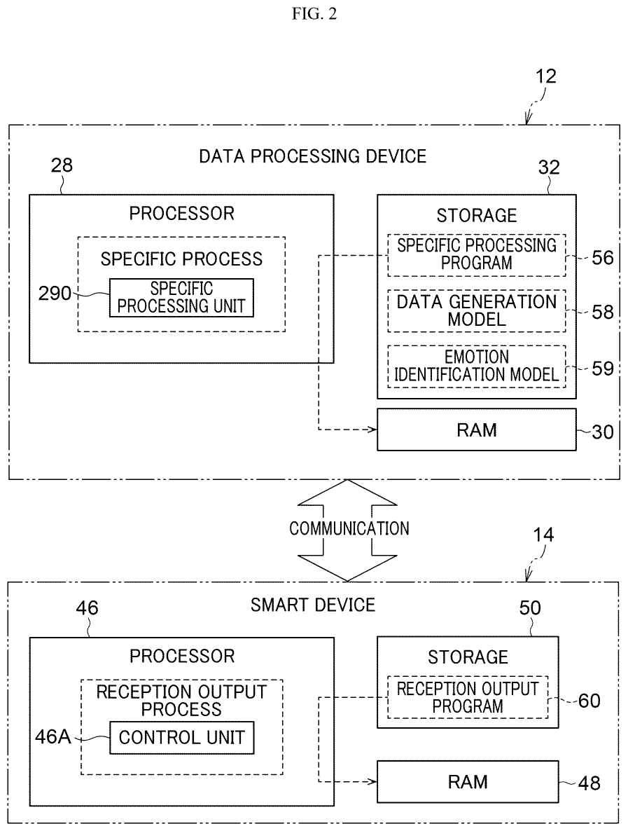

FIG. 2 illustrates an example of relevant functions of the data processing device 12 and the smart device 14.

As illustrated in FIG. 2, specific processing is performed by the processor 28 in the data processing device 12. A specific processing program 56 is stored in the storage 32. The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

A data generation model 58 and an emotion identification model 59 are stored in the storage 32. The data generation model 58 and the emotion identification model 59 are employed by the specific processing unit 290. The specific processing unit 290 uses the emotion identification model 59 to estimate an emotion of a user, and is able to perform the specific processing using the user emotion. In an emotion estimation function (emotion identification function) that uses the emotion identification model 59, various estimations, predictions, and the like are performed related to emotions of the user, include estimating and predicting the emotion of the user, however, there is no limitation to such examples. Moreover, estimation and prediction of emotion also includes, for example, analyzing (parsing) emotions and the like.

Reception and output processing is performed by the processor 46 in the smart device 14. A reception and output program 60 is stored in the storage 50. The reception and output program 60 is employed by the data processing system 10 in combination with the specific processing program 56. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48. Note that a configuration may be adopted in which a similar data generation model and emotion identification model to the data generation model 58 and the emotion identification model 59 are included in the smart device 14, and these models are used to perform similar processing to the specific processing unit 290. The reception and output program is implemented by the processor 46 operating as the control unit 46A according to the reception and output program 60 executed in the RAM 48.

Note that devices other than the data processing device 12 may include the data generation model 58. For example, a server device (for example, a generation server) may include the data generation model 58. In such cases, the data processing device 12 performs communication with the server device including the data generation model 58 to obtain a processing result (prediction result or the like) obtained using the data generation model 58. The data processing device 12 may be a server device, and may be a terminal device owned by the user (for example, a mobile phone, a robot, a home electrical appliance, or the like). Next, description follows regarding an example of processing by the data processing system 10 according to the first exemplary embodiment.

### Example 1

Description follows regarding a flow of the specific processing in an Example 1. The units of the system described below are implemented by the data processing device 12 and the smart device 14. The data processing device 12 is called a “server” and the smart device 14 is called a “terminal”.

Conventional computer-implemented recipe recommendation systems typically rely on rigid, form-based inputs and static rule engines. Such systems generally require users to manually specify structured parameters, such as ingredient names and cooking time, in predefined fields. As a result, these systems are not well suited to process heterogeneous user inputs, including free-form natural language, speech, or images of available ingredients. When the user deviates from the expected format, existing systems often fail to correctly interpret the user's intent, which leads to inaccurate or irrelevant recipe suggestions.

Furthermore, many existing systems do not generate a machine-optimized intermediate representation that can be effectively used to drive downstream artificial intelligence components. In particular, they do not automatically transform multi-modal inputs into normalized condition information or specialized prompt sentences tailored for a generative AI model. Instead, they rely on ad hoc text concatenation or simplistic keyword matching, which can produce suboptimal prompts, degraded model performance, and inconsistent results. In addition, the processing pipelines of known systems are typically monolithic and not designed to generate structured, machine-readable recipe data. These systems often provide only unstructured text responses that are not easily parsed or reused by other computer processes. As a result, it is difficult for the computing system to perform automated consistency checks, generate summarized instructions suitable for different user interfaces, or integrate seamlessly with other services such as food service providers and delivery services.

Moreover, conventional solutions lack an efficient mechanism to leverage emotion analysis and visual guidance within a unified, computer-optimized workflow. Existing systems do not systematically incorporate user emotional state into the construction of prompts for a generative AI model, and do not automatically generate or associate visual information links that present cooking procedures in a user-friendly, visual manner. Consequently, the overall user experience is limited, and the underlying computing resources are not fully utilized in a coordinated way. Accordingly, there is a need for an improved computer-implemented system and method that can (i) robustly acquire and fuse multi-modal user inputs, (ii) convert the fused inputs into normalized condition information, (iii) automatically generate high-quality prompt sentences for a generative AI model, (iv) obtain and structure candidate recipe information into machine-readable data, (v) generate summarized cooking procedures, and (vi) associate visual information links and external ordering options, all within a cohesive processing architecture. Such a system should enhance the functioning of the underlying computer by providing more reliable parsing, normalization, model interaction, and downstream data handling, thereby improving both computational efficiency and the quality of generated results.

The specific processing by the specific processing unit 290 of the data processing device 12 in Example 1 is realized by the following means.

The present invention provides a server comprising a processor and an input/output device, wherein the processor is configured to acquire, via the input/output device, information regarding ingredients, required time, preferences, and number of servings from a user; to convert audio information acquired from the input/output device into character information by speech recognition processing, to convert image information acquired from the input/output device into ingredient information by image recognition processing, and to integrate the character information, the ingredient information, and character information directly input by the user to generate integrated text information representing a request of the user; to execute natural language processing on the integrated text information to extract structured condition information including the ingredients, the required time, the preferences, and the number of servings, and to normalize the structured condition information to generate standardized condition information; to generate a prompt sentence in natural language including the standardized condition information by embedding the standardized condition information into a predetermined sentence template, the prompt sentence being configured to be input to a generative AI model; to input the prompt sentence to the generative AI model disposed externally or internally with respect to the server, and to obtain, from the generative AI model, candidate recipe information for a dish, the candidate recipe information including a dish name, a list of materials, and cooking procedures; to analyze the candidate recipe information and convert the candidate recipe information into a recipe data structure in a machine-readable format including the dish name, material items, and a plurality of step information items representing the cooking procedures; to shorten the cooking procedures included in the recipe data structure by rule-based processing or summarization processing using the generative AI model, and to generate summarized cooking method information; to search for or generate, based on the dish name and the ingredient information, a visual information link indicating a reference destination for visual information that visually presents a cooking method of the dish; to transmit the candidate recipe information, the summarized cooking method information, and the visual information link to the input/output device, and to cause the input/output device to display the candidate recipe information, the summarized cooking method information, and the visual information link; and to search, based on the dish selected by the user, a food providing facility or a delivery providing service that provides the dish, and to provide order support information via the input/output device. This enables the computer system to improve processing of heterogeneous user inputs, to generate optimized prompt sentences for a generative AI model, to produce structured and summarized recipe data suitable for automated manipulation and display, and to integrate visual guidance and ordering functions in a unified, technically enhanced workflow.

The term “processor” refers to a hardware information processing unit, such as a central processing unit or other computing circuitry, that executes instructions to perform the functions described herein.

The term “input/output device” refers to a hardware interface, such as a display, touch panel, keyboard, pointing device, microphone, camera, or network communication module, that enables input from and output to a user or an external system.

The term “user” refers to a human operator or entity that provides information to the system and receives information from the system through the input/output device.

The term “ingredients” refers to food components or raw materials usable for preparing a dish and provided as part of the information from the user.

The term “required time” refers to a time constraint or allowable duration specified by the user for completing preparation and cooking of a dish.

The term “preferences” refers to one or more conditions reflecting a user's taste, style, dietary restrictions, or other subjective requirements relating to a dish.

The term “number of servings” refers to the quantity of portions, persons, or serving units for which the user desires the dish to be prepared.

The term “audio information” refers to digital data representing sound, including spoken utterances of the user captured by a microphone.

The term “speech recognition processing” refers to a computerized procedure that analyzes audio information and converts the audio information into character information representing recognized text.

The term “image information” refers to digital data representing a still image or sequence of images captured by an image sensor or camera.

The term “image recognition processing” refers to a computerized procedure that analyzes image information and detects or classifies objects, including food items, to generate ingredient information.

The term “character information” refers to alphanumeric or symbolic text data obtained from user input or produced by speech recognition processing.

The term “ingredient information” refers to data specifying one or more detected or identified ingredients derived from image recognition processing or directly provided by the user.

The term “integrated text information” refers to text data that results from combining character information obtained from different input modes, including speech-derived text, image-derived ingredient information, and direct text input from the user, into a unified representation of a user request.

The term “natural language processing” refers to computerized analysis of human language text to perform operations such as tokenization, parsing, entity extraction, classification, or semantic interpretation.

The term “structured condition information” refers to data representing conditions, including ingredients, required time, preferences, and number of servings, organized in a predefined data structure with explicit fields.

The term “standardized condition information” refers to normalized structured condition information in which values are converted into canonical formats, such as standardized ingredient labels, time expressions, and preference categories.

The term “prompt sentence” refers to a natural language text sequence constructed to be provided as input to a generative AI model so as to direct the generative AI model to perform a specific task.

The term “sentence template” refers to a predefined natural language pattern or framework into which standardized condition information is embedded to generate a prompt sentence.

The term “generative AI model” refers to a machine learning model that generates text or related content in response to input information, based on patterns learned from training data.

The term “candidate recipe information” refers to data output from the generative AI model that describes one or more proposed dishes, including elements such as a dish name, a list of materials, and cooking procedures.

The term “dish name” refers to a textual label or title that identifies a specific dish or recipe generated or selected by the system.

The term “list of materials” refers to a collection of ingredient entries, each entry describing a material required for preparing a dish, such as ingredient type and amount.

The term “cooking procedures” refers to one or more operations or actions, organized as steps, that describe how to prepare and cook a dish.

The term “recipe data structure” refers to a machine-readable organization of candidate recipe information, including fields for a dish name, material items, and multiple step information items representing cooking procedures.

The term “material items” refers to individual elements in the list of materials, each specifying an ingredient and optionally an associated quantity or unit.

The term “step information” refers to data describing a discrete operation or stage within the cooking procedures, such as preparation, heating, mixing, or serving.

The term “rule-based processing” refers to processing performed according to predefined algorithmic rules or conditions, without requiring learning from training data, to transform or filter information.

The term “summarization processing” refers to computerized processing that reduces the length or complexity of a text while retaining important information, including summarization performed by a generative AI model.

The term “summarized cooking method information” refers to a condensed representation of cooking procedures, derived from the recipe data structure by rule-based processing or summarization processing.

The term “visual information” refers to media content, such as images, video, or animations, that graphically presents information about a dish or cooking method.

The term “visual information link” refers to a reference, such as a uniform resource locator or other address information, that indicates a location at which visual information related to a dish or cooking method can be accessed.

The term “food providing facility” refers to an establishment that prepares and serves food to customers, such as a restaurant or similar service provider.

The term “delivery providing service” refers to a service that delivers prepared food or related items from a provider to a user.

The term “order support information” refers to information used to assist a user in placing an order with a food providing facility or delivery providing service, including identifiers, menu information, or operation guidance.

The term “emotion analysis” refers to computerized detection or estimation of a user's emotional state, sentiment, or affect based on textual or other input data.

The term “instruction information based on an emotional state” refers to data indicating constraints, style preferences, or control parameters derived from or adjusted according to an estimated emotional state of the user, for use in constructing a prompt sentence.

The term “operation screen” refers to a user interface screen displayed on the input/output device that presents information and interactive elements allowing the user to execute operations such as ordering, selection, or navigation.

In one embodiment, a server cooperates with one or more terminals used by a user to implement the claimed system. The terminal is, for example, a smartphone, a tablet computer, or a personal computer, and includes a display, a touch panel, a microphone, a camera, and a wireless or wired communication interface. The server is, for example, a rack-mounted or cloud-based computing device including a central processing unit (CPU), a memory, a non-volatile storage device, and optionally a graphics processing unit (GPU). The server executes server-side software comprising an operating system such as a general-purpose server operating system, a web server such as a general-purpose HTTP server, an application framework such as a general-purpose web application framework, and middleware libraries for speech recognition, image recognition, and natural language processing.

The terminal provides a graphical user interface implemented by an operating system user interface toolkit such as a mobile user interface framework or a desktop user interface framework. The terminal displays input components including text fields for manual entry of ingredients, required time, preferences, and number of servings, buttons for starting and stopping audio recording, and controls for capturing still images or selecting stored images representing ingredients. The terminal acquires raw user input as text strings, compressed digital audio data, and digital image data, and transmits these data items to the server using a secure transport protocol such as HTTPS.

The server stores the received data in a memory-resident data structure that includes fields for raw text, audio binary data, image binary data, and metadata such as timestamps and user identifiers. The server then uses a speech recognition module to process the audio binary data. In one embodiment, the server invokes an automatic speech recognition engine via an application programming interface. The speech recognition engine performs feature extraction by computing Mel-frequency cepstral coefficients from incoming audio frames, applies an acoustic model implemented by a deep neural network such as a recurrent neural network or a transformer-based encoder, and decodes the most probable token sequence using a language model and beam search. The server receives a recognized text string such as “chicken, within 30 minutes, spicy, for two people” and stores this string as character information linked to the corresponding request.

The server also uses an image recognition module to process image binary data. In one embodiment, the server loads a convolutional neural network implemented in a framework such as a general-purpose deep learning framework and stored in the server's non-volatile memory. The neural network has multiple convolutional, pooling, and fully-connected layers trained to classify food items. The server converts each image into an RGB tensor, normalizes pixel values, and forwards the tensor through the neural network. The neural network outputs probability scores over a vocabulary of ingredient classes. The server selects one or more ingredient labels whose probabilities exceed a threshold, such as “chicken breast,” “onion,” or “bell pepper,” and stores these labels as ingredient information derived from the image.

The server integrates multiple input modalities by constructing integrated text information. The server concatenates or merges the direct text input, the speech-recognized text, and the ingredient labels derived from images into a single text passage. The server may apply deterministic rules to remove duplicates and normalize capitalization and punctuation. For example, the server may generate integrated text information such as: “I have chicken breast, onion, and bell pepper, I want a spicy dish that can be cooked within 30 minutes for 2 people.” By integrating heterogeneous inputs into a single textual representation, the server can treat the downstream language processing in a unified manner, which simplifies the internal data flow and reduces the number of separate parsing pipelines.

The server performs natural language processing on the integrated text information to extract structured condition information. In one embodiment, the server uses a natural language processing library that provides tokenization, part-of-speech tagging, and named entity recognition. The server defines domain-specific grammar rules and pattern matchers to extract entities corresponding to ingredients, time expressions, taste preferences, and serving counts. The server converts expressions such as “within half an hour” into a numeric time limit in minutes, maps phrases such as “for two people” to an integer serving count, and identifies lexemes such as “spicy” as preference tags. The server stores these values in a structured record including explicit fields for ingredients, required time, preferences, and number of servings.

The server then generates standardized condition information by normalizing the structured condition information. The server uses a synonym dictionary and a unit conversion module. For example, the server maps “chili hot” and “spicy” to a common preference category such as SPICY, and converts time expressions expressed in hours or seconds into a unified minute-based representation. The server also maps ingredient names to standardized identifiers maintained in a reference table, thereby eliminating lexical variation such as “chicken thigh” versus “thigh meat of chicken” when appropriate. This normalization improves the consistency of data that will be embedded into a prompt sentence and allows the generative AI model to receive more stable and predictable conditions, which in turn reduces variance and improves the reproducibility of generated recipes.

The server constructs a prompt sentence in natural language using a sentence template. The server stores one or more sentence templates as parameterized strings such as: “You are a cooking assistant. Using the ingredients {INGREDIENTS}, please create a {PREFERENCE} dish for {SERVINGS} people that can be cooked within {TIME} minutes. Provide a recipe with a title, a list of ingredients with quantities, and step-by-step instructions.” The server embeds the standardized condition information into the placeholders of the template to generate a complete prompt sentence. For example, the server may generate the following prompt sentence:
“You are a cooking assistant. Using the ingredients chicken breast, onion, and bell pepper, please create a spicy main dish for 2 people that can be cooked within 30 minutes. Provide a recipe with a title, a list of ingredients with quantities, and step-by-step instructions.”

In another example, the server may generate a different prompt sentence depending on user preferences for cuisine style or complexity, such as:
“Please propose a spicy chicken dish for 2 people that can be cooked within 30 minutes. Provide a detailed recipe including ingredients with quantities and step-by-step instructions.” By using predefined sentence templates and normalized condition data, the server reduces the number of tokens needed to specify constraints and increases the likelihood that the generative AI model adheres to the specified conditions, thereby improving both computational efficiency and output accuracy compared to naive concatenation of raw user text.

The server interacts with a generative AI model to obtain candidate recipe information. In one embodiment, the generative AI model is a transformer-based language model deployed either on the same server infrastructure or on a remote computing resource accessed via an application programming interface. The generative AI model includes multiple layers of self-attention and feed-forward networks and has been pre-trained on large corpora of text and further fine-tuned on cooking-related texts. The server encodes the prompt sentence into token identifiers, applies positional encodings, and forwards the token sequence to the generative AI model. The generative AI model computes attention weights over previous tokens to generate conditional probability distributions for subsequent tokens and outputs a sequence of tokens representing the candidate recipe information.

The server sets model parameters such as sampling temperature, maximum output length, and nucleus sampling probability (top-p) to balance diversity and determinism. The server may adjust these parameters based on the required time or the user's expertise level. For example, the server may reduce the temperature and output length for “beginner” users to produce shorter, more deterministic instructions, which can reduce confusion and improve comprehensibility. This parameter control is implemented by server-side algorithmic rules rather than manual intervention, demonstrating a non-trivial adaptation of the generative AI model that improves the behavior of the underlying computer system.

The server receives the generated token sequence and converts it back into text representing the candidate recipe information, which typically contains a dish name, a list of ingredients with quantities, and step-by-step instructions. The server then analyzes the returned text to build a recipe data structure. The server identifies section boundaries using rule-based heuristics, for example by detecting headings such as “Ingredients” and “Instructions,” and by detecting numbered lists or bullet markers. The server extracts the dish name, parses each ingredient line into an ingredient name and a quantity value, and parses each instruction line into a discrete step information item. The server stores this structured information in a machine-readable data structure such as an object with fields for dish_name, ingredients, and steps.

The server generates summarized cooking method information based on the structured recipe data. In one embodiment, the server applies rule-based summarization by extracting the main verb and object from each step and constructing a short sequence of imperative phrases. In another embodiment, the server sends a secondary prompt sentence and the full instructions to the generative AI model. An example of such a prompt sentence is:
“Summarize the following recipe steps into 3-4 short bullet points suitable as a quick reference, preserving key actions and cooking times.”

By converting the full instructions into a compact form by either a deterministic algorithm or a controlled generative summarization process, the server reduces the amount of text that must be rendered at once on the terminal and decreases the cognitive load on the user, which is particularly useful on small displays. From a technical perspective, this reduces network bandwidth and display rendering time because the terminal can selectively request or render only the summarized portion when appropriate.

The server searches for or generates a visual information link that indicates a location of visual information such as an image sequence or a video that demonstrates the cooking procedure of the dish. In one embodiment, the server stores a database of visual resources indexed by ingredients and cuisine categories. The server constructs a query using the dish name and one or more standardized ingredient identifiers and retrieves a matching entry from the database. The entry includes a uniform resource locator pointing to a media server that streams instructional content. By performing this lookup using normalized keys derived from the standardized condition information, the server avoids repeated full-text search and improves lookup speed and cache hit rates, which leads to reduced latency.

The server transmits the candidate recipe information, the summarized cooking method information, and the visual information link to the terminal in a structured format. The terminal receives the structured data, maps them to internal data models, and renders multiple views. The terminal may first display the summarized cooking method information and a “Show full recipe” control, then display the detailed ingredients and steps when the user requests them. The terminal may also provide a “Watch video” control that opens the visual information link in a media viewer. By leveraging structured data rather than unstructured text, the terminal can efficiently update specific portions of the interface without reloading entire pages, which reduces communication overhead and improves responsiveness.

The server can further incorporate emotion analysis into the prompt sentence. In one embodiment, the server uses an emotion classifier implemented as a neural network that accepts text embeddings and outputs emotion scores such as “happy,” “stressed,” or “tired.” The server generates text embeddings from the integrated text information using a pre-trained encoder network and applies a multi-layer perceptron with a softmax output layer. The server then selects an emotion label with the highest probability and stores this as the emotional state of the user. The server appends instruction information based on the emotional state to the prompt sentence, for example: “The user is stressed, please suggest an easy-to-cook dish with minimal steps and low risk of failure.” By explicitly encoding the emotional state into the prompt, the server alters the search space and output distribution of the generative AI model in a controlled manner, which changes not only the content but also the complexity of the generated recipe. This emotion-aware prompting is implemented as a specialized control mechanism that improves the appropriateness of the output relative to user context and thus improves the effectiveness of the computing system.

The server can be configured to search for food providing facilities or delivery providing services that offer the same or similar dish selected by the user. The server uses the standardized dish name and ingredient identifiers to formulate search queries against a database of menu items. The server then generates order support information such as facility identifiers, menu item identifiers, and ordering instructions. Although this functionality has a business aspect, the technical contribution resides in the reuse of the standardized condition information and structured recipe data to perform efficient matching, which reduces the need for fuzzy queries and lowers the computational load on the database engine.

The generative AI model used by the server is trained in advance using a mixture of unsupervised and supervised learning techniques. In one embodiment, the model is first pre-trained on a large collection of general text to learn general language patterns using a cross-entropy loss function and stochastic gradient descent with adaptive learning rate. The model is then fine-tuned on a corpus of cooking-related texts, where the training data includes example prompt sentences and corresponding recipes. During fine-tuning, the server applies data augmentation methods such as synonym substitution and ingredient scaling to increase robustness. The server stores the resulting model parameters in a compressed format and loads them into memory when needed. This structured training and deployment pipeline allows the server to achieve high-quality text generation while keeping inference latency within practical bounds.

The described configuration improves computer technology in several ways. By introducing standardized condition information and template-based prompt generation, the server reduces entropy in the input to the generative AI model, which leads to more stable and predictable outputs, decreasing the number of regeneration cycles and reducing total computation time. By integrating multimodal input processing (speech and image recognition) into a unified integrated text representation, the server eliminates the need for separate pipelines and redundant parsing, which reduces memory usage and simplifies error handling. By using structured recipe data rather than unstructured text, the server enables efficient incremental updates and partial rendering on the terminal, which reduces communication bandwidth and rendering time. By controlling generative AI model parameters and augmenting prompts based on emotion analysis and user preferences, the server optimizes the trade-off between accuracy and computational cost at run time.

Alternative embodiments are also possible. The server may omit the speech recognition module and operate solely on text and images, or may omit the image recognition module and operate solely on text and audio. The generative AI model may be replaced with a smaller model for devices with limited resources, where the server chooses different decoding strategies such as greedy decoding instead of nucleus sampling to reduce computation. The terminal may be a smart appliance such as a network-connected cooking device, and the server may send structured commands derived from the recipe data structure to control the appliance, such as adjusting heating temperature or cooking time. In such a configuration, the server's standardized condition information and step information items are used not only for display but also for machine control, directly tying the generative AI model's output to physical device settings and thereby demonstrating a concrete technical use of the claimed system.

In all embodiments, the server, the terminal, and the user interact within a coherent architecture in which the server performs multimodal integration, normalization, prompt sentence generation, generative AI model interaction, structured recipe construction, summarization, and visual link association. These operations are implemented as specific data structures, algorithms, and control rules that go beyond mere automation of human mental processes and contribute to improved speed, accuracy, and efficiency of the underlying computer system.

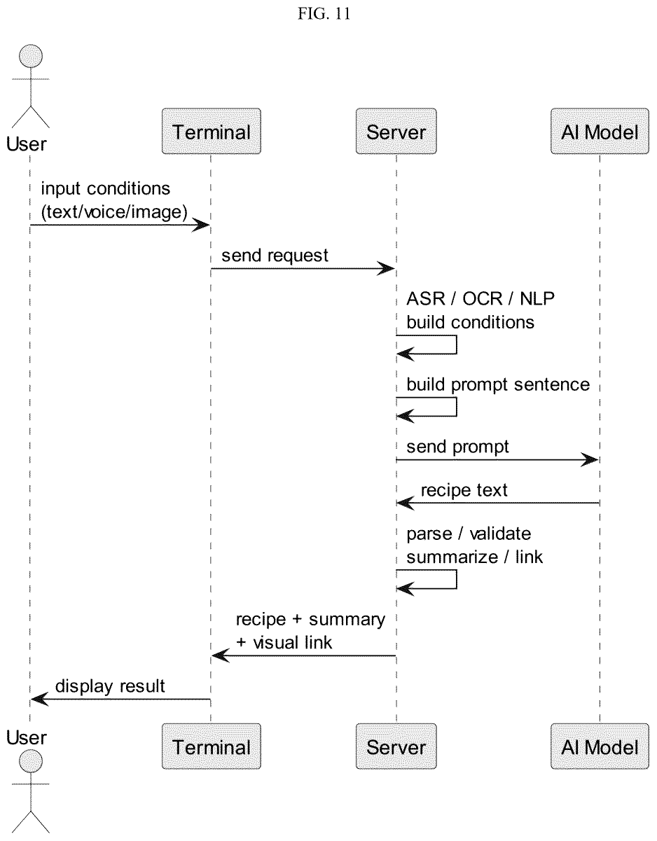

The following describes the processing flow using FIG. 11.

### Step 1:

The terminal displays an input screen to the user.

The terminal uses its operating system user interface framework to render text fields for ingredients, required time, preferences, and number of servings, as well as buttons for audio recording and image capture.

Input: No user data yet; the terminal receives layout definitions from an application module. Processing: The terminal converts these layout definitions into concrete UI components and binds event handlers for user actions such as tapping buttons or entering text.

Output: A visible screen that allows the user to start entering cooking conditions and to trigger audio or image acquisition.

### Step 2:

The user provides cooking condition information via the terminal.

The user types text such as “chicken, within 30 minutes, spicy, 2 people,” presses a button to record speech describing available ingredients, or captures images of the ingredients using the built-in camera.

Input: The user's manual actions (keystrokes, taps, voice, camera trigger).

Processing: The user mentally selects desired constraints (ingredients, time, taste, servings) and expresses them as text, speech, or images.

Output: Human-generated raw content that is captured as digital text, audio, and image signals inside the terminal.

### Step 3:

The terminal acquires and packages the user input.

The terminal stores text input as character strings, records audio through the microphone as compressed audio frames, and captures still images as pixel arrays.

Input: Raw text typed by the user, audio waveform from the microphone, and image frames from the camera sensor.

Processing: The terminal encodes audio to a standard format, encodes images to a compressed format, associates timestamps and session identifiers, and groups the text, audio, and image data into a single request object.

Output: A structured request object containing fields for raw text, audio data, image data, and metadata.

### Step 4:

The terminal transmits the structured request to the server.

The terminal opens a secure network connection and sends the packaged data to a predefined server endpoint.

Input: The structured request object created in Step 3.

Processing: The terminal serializes the request object into a network message (for example, JSON plus binary attachments), applies encryption at the transport layer, and addresses the message to the server's network address.

Output: An HTTPS request carrying the user's text, audio, and image input to the server.

### Step 5:

The server receives and validates the incoming request.

The server's web application framework parses the HTTP headers and body to reconstruct the structured request object.

Input: The HTTPS request transmitted by the terminal.

Processing: The server checks for required fields, verifies content types, and confirms that the request is within allowed size limits; if validation fails, the server prepares an error response, otherwise it accepts the payload for further processing.

Output: A validated internal representation of the user's raw text, audio data, image data, and metadata.

### Step 6:

The server converts audio data into character information using speech recognition processing.

The server forwards the audio portion of the request to a speech recognition module and receives recognized text.

Input: The audio data field from the validated request.

Processing: The server segments the audio into frames, extracts acoustic features, feeds the features into an acoustic model (such as a recurrent or transformer-based neural network), applies a language model to decode likely word sequences, and combines them into a text string.

Output: Character information representing the user's spoken description, stored as a text string in the server's memory.

### Step 7:

The server converts image data into ingredient information using image recognition processing. The server processes each received image through an image classification model trained on food items.

Input: The image data field from the validated request.

Processing: The server decodes each compressed image into pixel tensors, runs them through a convolutional or transformer-based vision network, computes class probabilities, and selects one or more ingredient labels whose probabilities exceed a threshold.

Output: Ingredient information represented as a list of standardized ingredient labels derived from the images.

### Step 8:

The server integrates multi-modal character information into integrated text information.

The server combines direct text input, speech-recognized text, and image-derived ingredient labels into a single coherent textual description.

Input: The raw text entered by the user, the character information from Step 6, and the ingredient labels from Step 7.

Processing: The server concatenates the different text segments, removes duplicates using string comparison, normalizes spelling and capitalization, and inserts connective phrases so that the result forms a grammatically coherent sentence or paragraph.

Output: Integrated text information that comprehensively represents the user's request in natural language.

### Step 9:

The server extracts structured condition information from the integrated text information using natural language processing.

The server analyzes the integrated text to identify specific data fields for ingredients, required time, preferences, and number of servings.

Input: The integrated text information from Step 8.

Processing: The server tokenizes the text, applies part-of-speech tagging and entity recognition, matches domain-specific patterns for time expressions and quantity phrases, and populates a structured record with explicit fields corresponding to each detected condition.

Output: Structured condition information containing separate fields for ingredients, time constraint, taste preferences, and serving count.

### Step 10:

The server normalizes the structured condition information to generate standardized condition information.

The server standardizes vocabulary and units so that subsequent processing uses consistent representations.

Input: The structured condition information from Step 9.

Processing: The server maps synonyms to canonical ingredient and preference identifiers, converts all time values to minutes, and resolves different linguistic expressions of serving counts into integer numbers; the server may also filter out unsupported or ambiguous entries based on predefined rules.

Output: Standardized condition information consisting of normalized ingredient identifiers, a numeric time limit, standardized preference tags, and a standardized number of servings.

### Step 11:

The server generates a prompt sentence for the generative AI model using a sentence template. The server embeds the standardized condition information into a predefined text template.

Input: The standardized condition information from Step 10 and one or more stored sentence templates.

Processing: The server selects a suitable template based on factors such as language setting and user level, replaces placeholder tokens with concrete values from the standardized condition information, and constructs a complete natural language instruction.

Output: A prompt sentence such as “Please propose a spicy chicken dish for 2 people that can be cooked within 30 minutes. Provide a detailed recipe including ingredients with quantities and step-by-step instructions.”

### Step 12:

The server optionally augments the prompt sentence with emotion-based instruction information. The server analyzes the integrated text to estimate the user's emotional state and modifies the prompt sentence accordingly.

Input: The integrated text information from Step 8 and the initial prompt sentence from Step 11. Processing: The server encodes the integrated text into a vector representation, feeds it into an emotion classification network that outputs emotion scores, selects the dominant emotion label, and appends a clause to the prompt sentence that instructs the generative AI model to adapt recipe complexity or style to the emotional state.

Output: An emotion-aware prompt sentence that includes both the standardized cooking conditions and emotion-based constraints.

### Step 13:

The server transmits the prompt sentence to the generative AI model and requests recipe generation.

The server calls the generative AI model's inference interface with the prompt sentence and configuration parameters.

Input: The (optionally emotion-augmented) prompt sentence from Step 11 or Step 12.

Processing: The server converts the prompt sentence into token IDs, sets generation parameters such as temperature, maximum tokens, and top-p, and sends these to the generative AI model hosted locally or remotely; the generative AI model processes the token sequence and returns a generated sequence representing a recipe.

Output: Candidate recipe information as generated text that includes at least a dish name, a list of ingredients with quantities, and step-by-step cooking instructions.

### Step 14:

The server parses the candidate recipe information into a structured recipe data structure.

The server converts the unstructured text into machine-readable fields.

Input: The candidate recipe text from Step 13.

Processing: The server detects section headers and line breaks, splits the text into title, ingredient lines, and instruction lines, and further parses ingredient lines into ingredient names and quantities using pattern rules; the server stores each instruction sentence or numbered line as a separate step item.

Output: A recipe data structure containing fields such as dish_name, an array of material items, and an array of step information items.

### Step 15:

The server performs validation and consistency checks on the recipe data structure.

The server ensures that the generated recipe is coherent with the user's conditions.

Input: The recipe data structure from Step 14 and the standardized condition information from

### Step 10.

Processing: The server verifies that mandatory fields are not empty, confirms that key ingredients from the standardized condition information appear in the material items, and compares the estimated total cooking time in the steps with the user's time constraint; if inconsistencies are detected, the server may adjust the recipe or regenerate it by issuing a modified prompt.

Output: A validated recipe data structure that satisfies basic completeness and consistency criteria.

### Step 16:

The server generates summarized cooking method information from the recipe data structure.

The server creates a condensed version of the cooking procedures.

Input: The validated recipe data structure from Step 15.

Processing: The server applies rule-based extraction of key actions from each step or sends the full step list to the generative AI model with a separate prompt sentence such as “Summarize the following recipe steps into 3-4 short bullet points suitable as a quick reference”; the server then collects and formats the resulting short instructions.

Output: Summarized cooking method information consisting of a small number of concise steps that capture the main actions and timings.

### Step 17:

The server determines a visual information link associated with the dish.

The server finds or constructs a link to visual media that explains the cooking procedure.

Input: The dish_name field from the recipe data structure and the standardized ingredient identifiers from Step 10.

Processing: The server generates a query using the dish_name and key ingredients, searches a visual media index or database for matching entries, selects the best match according to a similarity score, and retrieves or builds a uniform resource locator that points to the selected visual media.

Output: A visual information link that can be used by the terminal to retrieve a video or image-based demonstration of the recipe.

### Step 18:

The server generates order support information for external food or delivery services.

The server maps the selected dish to externally available menu items.

Input: The recipe data structure from Step 15 and a database of menu items from food providing facilities and delivery services.

Processing: The server compares standardized dish and ingredient identifiers with the menu database, selects one or more candidate matches, and compiles information such as provider identifiers, menu identifiers, and ordering options into a structured format.

Output: Order support information that can be presented to the user as options to purchase the same or a similar dish.

### Step 19:

The server composes a response message to the terminal.

The server aggregates all relevant outputs into a single payload.

Input: The validated recipe data structure from Step 15, the summarized cooking method information from Step 16, the visual information link from Step 17, and the order support information from Step 18.

Processing: The server serializes these elements into a response object with clearly defined fields, ensures that data sizes remain within communication limits, and attaches status and metadata required by the terminal application.

Output: A response message containing structured recipe data, summarized instructions, a visual link, and order support data.

### Step 20:

The terminal receives and renders the response for the user.

The terminal parses the response message and updates its user interface accordingly.

Input: The response message sent by the server in Step 19.

Processing: The terminal deserializes the structured data, maps fields to internal models, and draws UI components that show the dish name, summarized cooking method, detailed ingredients and steps, a control linked to the visual information link, and controls for initiating an order based on the order support information.

Output: A complete, interactive recipe presentation on the terminal's display that allows the user to understand the cooking process, access visual guidance, and optionally place an order with an external provider.

### Application Example 1

Description follows regarding a flow of the specific processing in an Application Example 1. The units of the system described below are implemented by the data processing device 12 and the smart device 14. The data processing device 12 is called a “server” and the smart device 14 is called a “terminal”.

Conventional recipe recommendation and food ordering systems typically rely on fixed rule engines or simple database filtering to suggest dishes based on user inputs such as ingredients, cooking time, and preferences. These systems suffer from several technical limitations. First, the processing pipeline from heterogeneous user inputs (voice, text, image) to structured query data is often fragmented, resulting in redundant parsing logic, inconsistent data structures, and increased processing latency. Second, conventional systems do not effectively leverage modern generative AI models in a controlled manner: prompts are ad hoc, model outputs are unstructured, and post-processing requires heuristic parsing, which leads to unstable behavior, high error rates, and inefficient use of computing resources. Third, when such systems attempt to integrate recipe suggestion, restaurant/delivery search, and cooking guidance (such as video links and summarized instructions), they typically treat these as separate modules with little coordination, causing duplicated data access, multiple inconsistent transformations of the same user context, and increased network and storage overhead. As a result, system responsiveness is degraded, computing and communication costs are increased, and it is difficult to provide reliable, personalized, end-to-end support from input to ordering and cooking guidance.

Furthermore, in many existing architectures, generative AI models are invoked with free-form natural language prompts that do not specify a target data structure or explicit selection indicators for optimal results. This makes it difficult for backend components to deterministically interpret the model output, to integrate the output with database records, and to drive downstream processes such as restaurant selection and order processing. The lack of a structured prompt design and corresponding parsing logic forces the system to perform repeated natural language analysis and ad hoc extraction, which is computationally expensive and prone to failure, thereby limiting system scalability and robustness.

In addition, conventional systems do not unify the generation of recipe proposals and the summarization of cooking procedures under a common prompt-driven framework. Different components independently implement summarization or formatting logic, which leads to code duplication, incompatibilities in output formats, and inefficient reuse of model results. These issues prevent a smooth user experience in which a single processing pipeline can accept user conditions, generate ranked candidate dishes in a structured manner, identify appropriate food-providing facilities or delivery services, and deliver both detailed and summarized cooking guidance with minimal additional processing.

Accordingly, there is a need for a technical framework that integrates structured preprocessing of user inputs, database-based candidate retrieval, and prompt-driven interaction with a generative AI model in a coordinated way. Such a framework should define explicit data structures and identification items in prompt sentences, thereby enabling deterministic interpretation and optimization of model outputs, reducing redundant natural language processing, and improving the overall efficiency, scalability, and reliability of the computer system that provides recipe recommendations, ordering support, and cooking guidance.

The specific processing by the specific processing unit 290 of the data processing device 12 in Application Example 1 is realized by the following means.

The present invention provides a server comprising a processor configured to receive, via an input/output device, information including ingredient information, required time information, preference information, number-of-persons information, and input-format information from a user terminal; to convert, when the input-format information indicates voice input, an audio signal into character string data and generate structured data by associating the character string data with respective items of the ingredient information, the required time information, the preference information, and the number-of-persons information; to execute, based on the structured data, search processing and aggregation processing on a cooking information set stored in an information storage device so as to extract a plurality of candidate cooking information items and generate cooking candidate information; to generate a prompt sentence for a generative AI model, the prompt sentence including item definitions, an output format, and evaluation indices defining a structure and content of a candidate cooking proposal result to be output by the generative AI model; to input the prompt sentence to the generative AI model, obtain and analyze the candidate cooking proposal result, and generate presentation data including a plurality of candidate cookings and priority information based on the structured data and the candidate cooking proposal result; to specify a cooking selected via the user terminal, search the information storage device or an external information providing device using identification information associated with the specified cooking, and generate order information for at least one food-providing facility or delivery service capable of providing the specified cooking; and to acquire cooking procedure information corresponding to the specified cooking, generate video link information and a summarization prompt sentence for the generative AI model based on the cooking procedure information, obtain summarized cooking procedure information from the generative AI model, and provide the video link information and the summarized cooking procedure information to the user terminal. This enables a unified and efficient computer-implemented pipeline that normalizes heterogeneous user inputs into structured data, coordinates database retrieval with structured prompt sentences for the generative AI model, deterministically interprets and optimizes model outputs, and seamlessly integrates recipe recommendation, ordering support, and cooking guidance while reducing redundant natural language processing and improving system responsiveness and scalability.

The term “processor” refers to a hardware or virtual computation unit, such as a central processing unit or a processing core, that executes program instructions to perform data acquisition, data processing, and control operations of the system.

The term “user terminal” refers to an electronic device operated by a user, such as a communication device or a computing device, that provides input to and receives output from the system via a communication network.

The term “input/output device” refers to a hardware or software interface, such as a communication interface, display interface, or user interface module, that enables the processor to receive information from the user terminal and to transmit information to the user terminal.

The term “ingredient information” refers to information representing one or more food components or materials specified by a user as usable or desired in a cooking process.

The term “required time information” refers to information indicating a time constraint or allowable time period for preparing or obtaining a cooking item.

The term “preference information” refers to information representing one or more user tastes, dietary tendencies, constraints, or selection criteria related to cooking, such as flavor preferences, spiciness, or nutritional preferences.

The term “number-of-persons information” refers to information indicating a quantity of consumers, serving count, or number of people for whom a cooking item is intended.

The term “input-format information” refers to information indicating a type or modality of user input, such as voice input, text input, or image input, that is used by the system to select an appropriate preprocessing operation.

The term “audio signal” refers to analog or digital data representing sound captured by a sensor, such as a microphone of the user terminal, and transmitted to the system for processing.

The term “speech recognition processing device” refers to a computing resource, such as software, hardware, or a remote service, configured to convert an audio signal into character string data by recognizing spoken content.

The term “character string data” refers to digital data representing a sequence of characters, such as letters, digits, and symbols, interpretable as natural language text.

The term “structured data” refers to data formatted according to a predetermined schema or structure, in which elements derived from user input are associated with defined fields, such as ingredient, required time, preference, and number-of-persons fields.

The term “information storage device” refers to a storage resource, such as a memory device, database, or storage system, that stores a cooking information set, recipe data, facility information, and other related information.

The term “cooking information set” refers to a collection of records, such as recipe records or dish records, each including at least cooking name information, ingredient information, procedure information, and optionally facility information or metadata.

The term “search processing” refers to an operation in which the processor accesses the information storage device and retrieves one or more records that satisfy or approximate specified conditions derived from the structured data.

The term “aggregation processing” refers to an operation in which the processor combines, filters, ranks, or summarizes search results or related data to generate higher-level information, such as aggregated candidate lists or statistical summaries.

The term “candidate cooking information” refers to information items corresponding to cooking records that have been selected as candidates by the search processing and aggregation processing, based on the user's conditions.

The term “cooking candidate information” refers to a summarized representation of a plurality of candidate cooking information items, including selected attributes, rankings, or evaluation values suitable for use in further processing or presentation.

The term “prompt sentence” refers to natural language or structured text data that is generated by the processor and provided as input to a generative AI model, the text data specifying a task, desired output format, or constraints for the generative AI model.

The term “generative AI model” refers to an artificial intelligence model, such as a language model or text generation model, that generates output data, including text or structured data, in response to an input prompt sentence.

The term “output format” refers to a specification included in the prompt sentence that defines a structure, such as a list, table, or data schema, in which the generative AI model is requested to output its response.

The term “evaluation indices” refers to criteria or parameters, such as relevance, estimated preparation time, user preference matching, or priority level, that are included in the prompt sentence or used by the processor to evaluate or rank candidate cookings.

The term “candidate cooking proposal result” refers to output data generated by the generative AI model in response to a prompt sentence, the output data including one or more proposed cookings, descriptions, and related evaluation information.

The term “presentation data” refers to data formatted for display or interaction at the user terminal, including candidate cooking names, descriptions, priority information, and any additional information required for user selection.

The term “priority information” refers to information that indicates a relative ranking, importance, or recommendation level of each candidate cooking among a plurality of proposed cookings.

The term “selection information” refers to data received from the user terminal that indicates a user choice among one or more presented candidate cookings.

The term “identification information” refers to data, such as an identifier, key, or code, that uniquely or specifically associates a selected cooking with a corresponding record in the information storage device or external information providing device.

The term “external information providing device” refers to an external system or service, such as a remote database or information server, that supplies facility information, delivery information, or related data to the system.

The term “food-providing facility” refers to an establishment, such as a restaurant or catering facility, capable of preparing and providing a cooking item corresponding to a selected cooking.

The term “delivery service” refers to a service entity, such as a transportation or logistics service, configured to deliver prepared food items from a food-providing facility to a user.

The term “order information” refers to data generated by the processor that specifies details of an intended order, including selected cooking information, facility or service information, quantity, and user-related data needed for order processing.

The term “cooking procedure information” refers to data describing steps, actions, or operations required to prepare a cooking item, including ingredient handling, sequence of steps, and timing.

The term “video providing device” refers to a service or system capable of storing and delivering moving image content, such as cooking instruction videos, in response to identification information.

The term “video identification information” refers to data used by the video providing device to identify a specific video resource, such as a video identifier, URL, or code.

The term “video link information” refers to data including at least video identification information and optionally additional metadata, enabling the user terminal to access a video corresponding to a selected cooking.

The term “summarization prompt sentence” refers to a prompt sentence generated by the processor and provided to the generative AI model, the prompt sentence instructing the generative AI model to generate a condensed or simplified representation of cooking procedure information.

The term “summarized cooking procedure information” refers to cooking procedure information that has been reduced or simplified by the generative AI model or the processor, typically into a shorter, more accessible sequence of steps.

The term “external order processing device” refers to an external system or service that receives order request data from the system, performs order processing such as acceptance and payment handling, and returns order confirmation information.

The term “order request data” refers to data transmitted from the processor to the external order processing device, including order information sufficient for the external order processing device to execute an order process.

The term “order confirmation information” refers to information returned from the external order processing device indicating a result of order processing, such as order acceptance, order identifier, expected delivery time, or payment status.

In one embodiment, the system includes a server, one or more terminals, and one or more external service devices that are interconnected via a communication network. The server includes at least one processor, a memory, a non-volatile storage device, and a network interface. The terminal includes a processor, a display, an input device such as a touchscreen, and optionally a microphone and a camera. The external service devices include at least an external speech recognition service, a video delivery service, and an order processing service.

The server executes software components implemented, for example, on an application platform such as a server-side runtime environment, a web framework, and a database management system. The server uses a document-oriented database as the information storage device and stores, in this database, a cooking information set including multiple recipe records. Each recipe record includes at least a recipe identifier, a title string, ingredient information (stored as a normalized list of ingredient identifiers and quantities), cooking procedure information (stored as a sequence of step objects with step order, textual instruction, and estimated duration), required time information, preference tags, and one or more facility identifiers indicating food-providing facilities capable of providing the corresponding dish. The server further stores, in the database, facility records including facility identifiers, type (restaurant, catering, or delivery-only), geographic location, delivery options, and supported recipes, and optionally stores video link data associated with the recipes.

The terminal presents a graphical user interface implemented, for example, as a web application using a presentation framework or as a native application on a mobile operating system. The terminal allows the user to specify conditions for recipe recommendation. The terminal displays input fields for ingredient information, required time information, preference information, and number-of-persons information. The terminal further offers a selection of input formats, including text input, voice input, and, in some embodiments, image input. When the user selects voice input, the terminal acquires an audio stream via the microphone and encapsulates the digital audio samples for transmission to an external speech recognition processing device.

The terminal transmits the audio stream or a compressed representation to the external speech recognition service via a secure communication channel. The external speech recognition service executes an acoustic model and language model to convert the audio stream into character string data representing the spoken content. The terminal receives the character string data from the external service and associates recognized phrases with the respective fields for ingredients, time, preferences, and number of persons. In some embodiments, the terminal performs local post-processing, such as keyword extraction and basic normalization, and transmits the resulting user input data in a structured format to the server.

The server receives user input data from the terminal via a network interface. The server stores the received data temporarily in memory and normalizes the data into structured data according to a predetermined schema. The structured data includes explicit fields for ingredient list, required maximum cooking time, flavor preference, dietary restrictions, number of persons, and optional location information. The server uses this structured data to generate database queries directed to the cooking information set stored in the storage device.

The server connects to the database and executes search processing using a query construction module. The server formulates queries that use indexed fields of the recipe records, such as ingredient identifiers, required time fields, and preference tags. The server may apply logical operators, range constraints, and tag matching to efficiently retrieve candidate recipes that satisfy or approximate the user's constraints. The server then performs aggregation processing on the retrieved recipes, such as ranking by degree of ingredient match, difference between required time and user-specified maximum time, and correspondence with preference tags.

The server generates cooking candidate information by summarizing the retrieved recipe records. The cooking candidate information includes, for each candidate recipe, at least a recipe identifier, title, primary ingredients, estimated cooking time, and calculated ranking score. The server stores this cooking candidate information in memory as a collection of objects that follow a predefined internal data structure. The server uses this structured representation to construct a prompt sentence for a generative AI model.

The server implements a prompt generation module that converts the structured data and the cooking candidate information into a natural language prompt sentence. The server designs the prompt sentence to contain explicit instructions to the generative AI model regarding the task, the required output format, and evaluation indices. The server, for example, includes in the prompt sentence the following text:
“The user has the following conditions:
Ingredients: chicken, tomato
Maximum cooking time: 30 minutes
Preference: spicy
Number of people: 2

Based on these conditions and the candidate recipes listed below, please act as a cooking recommendation assistant and propose several suitable dishes. For each dish, provide a name, a short description, and an estimated cooking time in minutes. Clearly indicate which dish is the single best recommendation. Present your answer in a structured, clearly separable form that can be parsed programmatically.”

The server, in some embodiments, appends a short list of candidate recipe titles and their main attributes to the prompt sentence so that the generative AI model can re-rank or refine the proposals. The server integrates item definitions for the desired output, such as “name,” “short description,” “estimated time,” and a field indicating whether the dish is the top recommendation. By embedding these item definitions into the prompt sentence, the server constrains the output of the generative AI model into a predictable structure that can be deterministically parsed, improving processing efficiency and reliability.

The generative AI model is implemented as a transformer-based neural network trained on large-scale text corpora, recipe-related data, and dialogue examples. The model comprises a plurality of encoder-decoder layers or decoder-only layers, multi-head self-attention modules, feedforward networks, and learned embedding matrices. During training, the model receives tokenized text sequences, including instructions and target responses, and optimizes model parameters by minimizing a cross-entropy loss between predicted tokens and ground-truth tokens. The model uses gradient-based optimization, such as stochastic gradient descent with adaptive learning rate, and updates internal weights through backpropagation. To improve generalization and robustness, the training process may include data augmentation techniques, regularization methods such as dropout, and fine-tuning on domain-specific recipe and cooking instruction corpora.

The server communicates with the generative AI model through an inference interface. In one embodiment, the generative AI model runs on a separate computational resource, such as a dedicated inference server or cloud-based AI service, and exposes an application programming interface. The server sends the prompt sentence as a textual request to the inference interface, together with inference parameters such as temperature, maximum output length, and top-k or top-p sampling thresholds. The generative AI model receives the prompt sentence, converts it into a token sequence, and performs forward propagation through its transformer layers to compute output token probabilities at each position. The model then generates an output token sequence that forms a candidate cooking proposal result.

The server receives the generated text as the candidate cooking proposal result and uses a parsing module to interpret the output according to the item definitions embedded in the prompt sentence. The server extracts each proposed dish, its description, estimated time, and the flag indicating whether the dish is the top recommendation. Because the prompt sentence enforces a structured and labeled format, the parsing module can use deterministic token splitting or pattern matching rules rather than general-purpose natural language understanding, thereby reducing computational complexity and error rates. This design improves both the speed and accuracy of converting model outputs into internal data structures suitable for further processing. The server combines the candidate cooking proposal result with the original structured data to generate presentation data. The presentation data includes a list of candidate dishes, each with a name, description, priority score, and correlation with the user's conditions. The server may compute an additional ranking score by combining the model-indicated top recommendation with the database-derived ranking and preference matching degree. This hybrid scoring method constitutes a non-conventional algorithm because it fuses symbolic database scores with continuous preference scores inferred by the generative AI model, rather than simply automating human selection criteria. The server formats the presentation data for efficient rendering on the terminal and transmits the presentation data to the terminal.

The terminal receives the presentation data and displays the candidate dishes using UI components such as cards or lists. The terminal presents the top recommendation with a distinct visual indication and allows the user to select a desired dish. When the user selects a dish, the terminal transmits selection information, including a recipe identifier and user location, back to the server.

The server, upon receiving the selection information, uses the recipe identifier as identification information to access the corresponding recipe record in the database. The server then reads associated facility identifiers from the recipe record and optionally performs a secondary search on a facility collection using location and availability constraints. The server thus extracts one or more food-providing facilities or delivery services capable of providing the selected dish. The server generates order information including at least the selected recipe identifier, facility identifier, number of persons, and user contact information. The server can then interface with an external order processing service, transmitting order request data that conform to the external service's protocol. The external order processing service returns order confirmation information, including an order identifier and estimated delivery time, which the server reformats and transmits to the terminal for display.

In addition to recipe recommendation and ordering, the server provides cooking guidance comprising video link information and summarized cooking procedure information. The server retrieves cooking procedure information associated with the selected recipe from the database. The server can include in each procedure step a unique step identifier, textual instruction, estimated duration, and optional multimedia references. The server then determines whether a pre-associated video identifier is stored for the recipe. If such a video identifier exists, the server creates video link information by combining the video identifier with a base URL or access token for a video providing service. If a video identifier does not exist, the server may perform a search against an external video content index using the recipe title and ingredients, and then store the retrieved identifier for subsequent requests.

The server uses the cooking procedure information to construct a summarization prompt sentence for the generative AI model. The server, for example, generates the following text:
“Here are detailed cooking instructions for a recipe. Please summarize these instructions into 4-6 concise steps that a home cook can follow easily. Keep each step short and clear, and preserve the correct order and dependencies between steps. Return the steps as a numbered list in plain text.”

The server appends the full set of detailed steps after this instruction text, separated by delimiters that indicate the start and end of the content to be summarized. The generative AI model processes this summarization prompt sentence using the same transformer-based architecture, but with temperature and length parameters adjusted to encourage concise and deterministic output.

The model generates a shorter set of steps that preserve the logical dependencies between actions, such as ingredient preparation, heating, mixing, and serving.

The server receives the summarized cooking procedure information, verifies that the number of steps and content meet predefined constraints, and stores the summary in memory. The server then transmits the summarized steps together with the video link information to the terminal. The terminal displays the summary as a step-by-step guide and provides a control, such as a button, to open the cooking video through a browser or embedded player.

This architecture produces technical effects beyond mere automation of human tasks. The server normalizes heterogeneous user inputs into a structured data format, which improves the efficiency of database queries and reduces parsing errors. The inclusion of explicit item definitions and evaluation indices in the prompt sentence allows the generative AI model to output data that can be deterministically parsed, thereby reducing the need for costly and error-prone natural language post-processing. The hybrid scoring and ranking process, which combines database-derived metrics with model-inferred recommendation markers, yields more accurate and personalized recommendations than either component alone, while maintaining predictable computational complexity.

The use of transformer-based generative AI models with explicitly controlled output formats increases the computational efficiency of the recommendation pipeline because the server can optimize query planning, caching of intermediate results, and batch processing of prompts. In some embodiments, the server groups requests with similar user conditions and generates joint prompts to the generative AI model, thereby reusing contextual embeddings and reducing network overhead. The structured prompt design and deterministic parsing rules further enable more aggressive caching of model outputs, because the system can recognize equivalent logical queries even when user phrasing differs.

In contrast to conventional rule-based recommendation engines, the server employs non-conventional rules and workflows that tightly couple database search, prompt construction, generative inference, and downstream integration. For instance, the server uses specific non-intuitive rules when deciding which candidate recipes to expose to the generative AI model, such as selecting only recipes that maximize diversity across ingredient categories while still meeting time constraints. This selection strategy improves the coverage of the candidate set presented to the generative AI model and leads to more varied yet constraint-compliant proposals. The server also employs rules that adjust the number of candidate recipes passed into the prompt based on system load and expected inference latency, thus dynamically balancing accuracy and responsiveness.

The system improves computer technology by reducing redundant processing stages, using specialized data structures that map directly between database records and generative outputs, and minimizing network traffic through structured prompts and compact representations. These improvements lead to faster response times, better scalability when serving a large number of concurrent users, and lower error rates in interpreting model outputs. In addition, because the generative AI model is guided by specific, machine-interpretable instructions rather than free-form prompts, the server can systematically test and validate behavior across different parameter settings, thereby enhancing reliability and enabling more robust integration into existing computing infrastructures.

In alternative embodiments, the server may host the generative AI model locally rather than using an external service. In such cases, the server stores model parameters in local storage and loads them into memory for inference. The server can execute the transformer network on specialized hardware, such as a graphics processing unit or tensor processing unit, further increasing processing throughput. The server may also adapt the training of the model by periodically performing fine-tuning on anonymized user interaction logs, using loss functions that emphasize alignment between generated proposals and user selections. The server may implement custom training schedules, regularization techniques, and parameter-efficient adaptation methods to incorporate new recipes and user preference patterns without retraining the entire model from scratch.

In further embodiments, the system can be adapted to devices other than conventional terminals. For example, the terminal may be a smart appliance, such as a connected cooking device, that uses the summarized cooking steps to automatically set temperature, timer, or cooking mode. In this case, the server's structured outputs and explicit step definitions allow deterministic mapping from abstract instructions to low-level device commands, which further demonstrates technical integration beyond abstract information processing.

By providing these detailed structures, modules, and data flows, the embodiments described above enable a person skilled in the art to implement the claimed invention and understand how the combination of structured data processing, database querying, and prompt-driven generative AI inference yields concrete improvements in computational efficiency, recommendation accuracy, error reduction, and resource utilization over conventional systems.

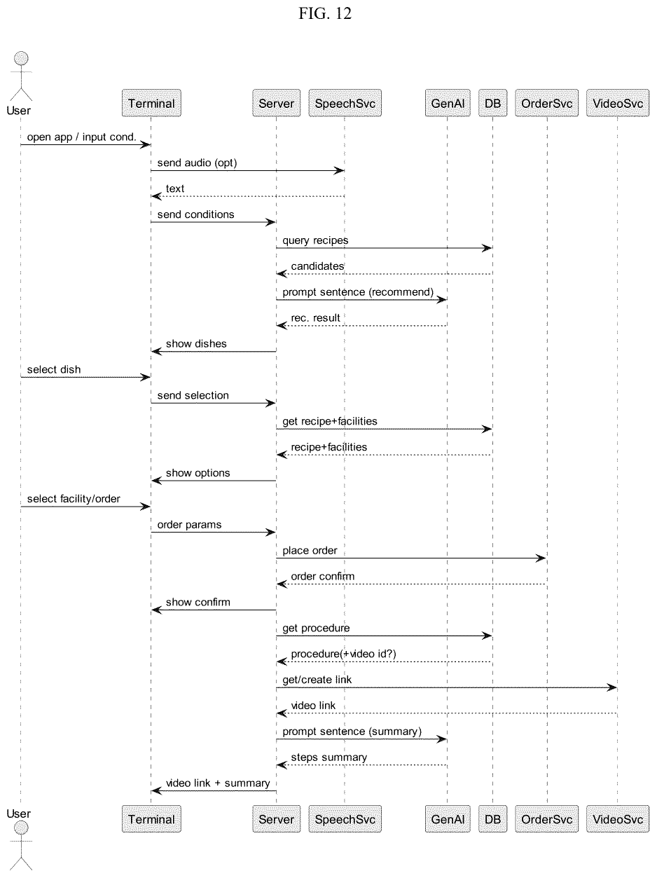

The following describes the processing flow using FIG. 12.

### Step 1:

The user operates the terminal and opens an application that provides a recipe recommendation interface. The user selects an input format (text or voice) and enters conditions such as ingredients, maximum cooking time, taste preferences, and number of persons. As input, the terminal receives raw user input data (typed text or audio samples) and a selected input-format type. As processing, the terminal maps the typed text directly to field values or, for voice input, buffers the audio samples and prepares a request payload. As output, the terminal produces a unified internal representation that includes the user's conditions and the input-format information.

### Step 2:

The terminal, when the user chooses voice input, transmits the audio signal together with metadata (sampling rate, language code, session ID) to an external speech recognition processing device via a network interface. As input, the terminal uses the buffered audio stream and user language settings. As processing, the terminal encapsulates the audio data into a request message, compresses it if necessary, and sends it over a secure channel. As output, the terminal receives character string data representing the recognized speech from the external service.

### Step 3:

The terminal converts the character string data into structured fields corresponding to ingredients, required time, preferences, and number of persons. As input, the terminal uses the recognized text and optionally UI context such as which field was active. As processing, the terminal applies keyword detection, pattern matching (for time expressions and numbers), and simple parsing rules to map segments of the text to specific fields. As output, the terminal generates a structured input object that includes ingredient information, required time information, preference information, number-of-persons information, and input-format information.

### Step 4:

The terminal transmits the structured input object to the server via a network communication interface. As input, the terminal uses the structured fields constructed in the previous step. As processing, the terminal serializes the object into a message format, attaches session identifiers and security tokens, and sends it to a predefined endpoint on the server. As output, the terminal provides the server with a request that contains normalized user conditions ready for backend processing.

### Step 5:

The server receives the request and validates the structured input object. As input, the server uses the serialized data from the terminal. As processing, the server deserializes the message, checks type consistency (for example, verifying that required time is numeric and that ingredient lists are non-empty), and performs range checks on values such as maximum cooking time. As output, the server produces a cleaned and validated structured data instance stored temporarily in memory.

### Step 6:

The server generates database queries to search a cooking information set stored in an information storage device. As input, the server uses the validated structured data, including ingredients, required time, preferences, and number of persons. As processing, the server constructs query filters that match ingredient identifiers, apply less-than-or-equal constraints on cooking time, and match preference tags. The server executes these queries against indexed fields in the database. As output, the server obtains a list of candidate recipe records that satisfy or approximate the user's constraints.

### Step 7:

The server performs aggregation and ranking on the candidate recipe records. As input, the server uses the set of recipe records returned by the database. As processing, the server calculates a score for each recipe based on degree of ingredient match, time difference relative to the user's limit, and alignment with preference tags. The server may normalize scores and sort the records by descending score. As output, the server produces cooking candidate information, which is a summarized list of candidate recipes with associated scores and key attributes.

### Step 8:

The server constructs a prompt sentence for a generative AI model using the structured user data and the cooking candidate information. As input, the server uses the normalized conditions and the ranked candidate list. As processing, the server concatenates natural language descriptions of the user's conditions and selected attributes of the candidate recipes into a coherent instruction text and embeds explicit item definitions for the desired output fields. As output, the server produces a prompt sentence such as:

“The user has the following conditions: Ingredients: chicken, tomato; Maximum cooking time: 30 minutes; Preference: spicy; Number of people: 2. Based on these conditions and the candidate recipes listed below, please propose several suitable dishes, provide a name, a short description, and an estimated cooking time for each, and clearly indicate which dish is the single best recommendation.”

### Step 9:

The server sends the prompt sentence to the generative AI model and controls inference parameters. As input, the server uses the constructed prompt sentence and configuration values such as temperature and maximum output length. As processing, the server wraps the prompt sentence and parameters into an inference request and transmits it to the generative AI model hosted on an AI service or dedicated inference server. As output, the server receives a candidate cooking proposal result, which is a text response generated by the model.

### Step 10:

The server parses the candidate cooking proposal result into a structured internal format. As input, the server uses the generated text from the generative AI model. As processing, the server applies deterministic parsing rules based on the known structure and labels specified in the prompt sentence, splits the text into individual dish entries, and extracts fields such as name, short description, estimated time, and top-recommendation flag. As output, the server generates a structured candidate list ready to be merged with database information.

### Step 11:

The server merges the structured candidate list from the generative AI model with the existing cooking candidate information obtained from the database. As input, the server uses both the model-generated list and the database-derived candidate list. As processing, the server aligns items by recipe identifiers or by similarity of names, adjusts ranking scores by combining model-indicated priorities with database scores, and removes duplicates or low-relevance entries. As output, the server produces presentation data that include final rankings, dish names, descriptions, and user-condition matching indicators.

### Step 12:

The server transmits the presentation data to the terminal for display. As input, the server uses the finalized presentation data. As processing, the server serializes the data into a compact form, attaches any necessary metadata (such as session ID and timestamp), and sends it via the network interface. As output, the terminal receives a response containing all information needed to render candidate cookings and their priorities.

### Step 13:

The terminal renders the candidate dishes for the user. As input, the terminal uses the presentation data from the server. As processing, the terminal parses the response, maps each candidate entry to a visual component, and displays dish names, short descriptions, estimated times, and a visual marker for the top recommendation. As output, the terminal produces a graphical user interface from which the user can select one of the proposed dishes.

### Step 14:

The user selects a desired dish from the presented list. As input, the user views the rendered candidates and interacts with the interface (for example, by tapping a card or clicking a button). As processing, the terminal detects the user action, determines which candidate entry is associated with the action, and extracts the corresponding recipe identifier and related data. As output, the terminal generates selection information that references the chosen dish.

### Step 15:

The terminal sends the selection information to the server to request facility and ordering options. As input, the terminal uses the selected recipe identifier and user context such as location or saved delivery address. As processing, the terminal packages this data into a request message and transmits it to the server. As output, the server receives a request indicating which dish the user has chosen and where service is needed.

### Step 16:

The server searches for food-providing facilities or delivery services capable of providing the selected dish. As input, the server uses the recipe identifier, facility linkage data in the recipe record, and user location information. As processing, the server queries facility records in the information storage device using filters on supported recipes, geographic distance, and availability, and may consult external information sources for up-to-date delivery conditions. As output, the server generates a list of candidate facilities or delivery services with attributes such as name, address, estimated delivery time, and price range.

### Step 17:

The server transmits facility and delivery options to the terminal. As input, the server uses the list of candidate facilities and their computed attributes. As processing, the server sorts the list by criteria such as distance, user rating, or estimated delivery time and encapsulates the sorted list into a response. As output, the terminal receives detailed options that the user can select for ordering.

### Step 18:

The terminal displays facility and delivery options and receives an order decision from the user. As input, the terminal uses the list returned by the server. As processing, the terminal renders each facility with its key attributes and provides controls for selection and order confirmation. As output, when the user confirms an order, the terminal produces order parameters including selected facility identifier, quantity, and any special instructions.

### Step 19:

The terminal sends order parameters to the server for order processing. As input, the terminal uses the selected facility identifier and user-entered order details. As processing, the terminal constructs an order request message and sends it to the server. As output, the server receives an order request for the selected dish and facility.

### Step 20:

The server generates order information and interfaces with an external order processing device. As input, the server uses the order parameters received from the terminal and facility information from the storage device. As processing, the server maps the requested dish to the facility's internal menu identifiers, constructs order information including items, quantities, prices, user contact information, and delivery address, and sends order request data to the external order processing device. As output, the server receives order confirmation information such as order ID and estimated delivery time.

### Step 21:

The server reformats the order confirmation information and returns it to the terminal. As input, the server uses the raw confirmation data from the external order processing device. As processing, the server converts codes and internal identifiers into user-friendly messages, attaches timestamps, and sets status flags (for example, “confirmed” or “pending payment”). As output, the server transmits a confirmation response that the terminal can present to the user.

### Step 22:

The terminal displays the order confirmation information to the user. As input, the terminal uses the confirmation response from the server. As processing, the terminal parses the response and updates the interface to show order status, order ID, and estimated delivery time. As output, the user sees a confirmation screen that reflects the external order state.

### Step 23:

The server retrieves detailed cooking procedure information for the selected dish from the information storage device. As input, the server uses the recipe identifier corresponding to the user's selected dish. As processing, the server reads the recipe's procedure steps, including text instructions and timing data, into memory. As output, the server generates a detailed set of cooking steps that will be used for video linking and summarization.

### Step 24:

The server generates video link information associated with the selected dish. As input, the server uses the recipe record, which may contain a stored video identifier, and configuration data for a video providing service. As processing, the server either constructs a video URL by combining the video identifier with a base path or, when no identifier exists, searches an external video index using the recipe name and ingredient keywords to obtain a suitable identifier. As output, the server produces video link information including a URL or video code that the terminal can access.

### Step 25:

The server constructs a summarization prompt sentence for the generative AI model using the detailed cooking procedure information. As input, the server uses the full list of steps and associated text. As processing, the server builds a natural language instruction that asks the generative AI model to reduce the instructions to a specified number of concise steps, preserving order and dependencies, and appends the full original steps after the instruction with clear delimiters. As output, the server produces a summarization prompt sentence ready for inference.

### Step 26:

The server sends the summarization prompt sentence to the generative AI model and obtains summarized cooking procedure information. As input, the server uses the summarization prompt sentence and inference parameters tailored for concise output. As processing, the server transmits the prompt to the AI model, receives the generated text, and checks that the returned content conforms to expected constraints, such as number of steps and clarity of formatting. As output, the server obtains a summarized set of cooking steps expressed as short, numbered instructions.

### Step 27:

The server sends the video link information and the summarized cooking procedure information to the terminal. As input, the server uses the generated video link and the validated summary steps. As processing, the server packages these elements into a response message and associates them with the user's current recipe context. As output, the terminal receives both the link to the instructional video and the compact cooking guide.

### Step 28:

The terminal displays the summarized cooking steps and provides access to the video link. As input, the terminal uses the summary and the video link information received from the server. As processing, the terminal renders the cooking steps in a list format, assigns step numbers, and presents a control that opens the video via a browser or embedded video player when activated. As output, the user can follow the concise on-screen instructions while optionally viewing the detailed video, thereby utilizing the full functionality of the system.

It is also possible to incorporate an emotion engine for estimating the user's emotions. That is, the specific processing unit 290 may estimate the user's emotions using an emotion identification model 59, and perform specific processing based on the estimated emotions.

### Example 2

Description follows regarding a flow of the specific processing in an Example 2. The units of the system described below are implemented by the data processing device 12 and the smart device 14. The data processing device 12 is called a “server” and the smart device 14 is called a “terminal”.

Conventional recipe recommendation systems primarily perform simple filtering on structured attributes, such as cooking time, number of servings, and basic category labels, in a database of cooking information. Such systems typically rely on rigid rule-based matching or simple ranking based on static scores. As a result, these systems are unable to effectively interpret natural-language condition information input by a user, particularly when the user expresses complex constraints, nuanced preferences, or context in free-text form. Further, conventional systems do not integrate large-scale language models in a way that systematically improves the underlying computational process, and thus cannot dynamically refine recommendation logic or explanation content in response to evolving user input.

In addition, traditional systems generally separate the database search stage from any advanced machine learning stage, so that database queries are executed using coarse conditions only, and any subsequent ranking is limited to straightforward scoring, without exploiting rich feature representations. This separation leads to suboptimal selection of candidate cooking information, reduced accuracy in ranking, and an inability to adapt ranking behavior based on user interaction history, emotional tendencies, or nuanced preference patterns.

Moreover, when generative artificial intelligence models are used at all, they are often invoked in an ad hoc manner, with manually crafted prompts that are not systematically derived from structured data or machine-learned ranking results. This causes instability in output quality, inconsistency in responses between sessions, and increased computation on both the server and the model side due to redundant or poorly targeted requests. The absence of a structured pipeline for generating prompt sentences from refined, machine-selected cooking information leads to inefficient utilization of computational resources, as well as longer response times and degraded user experience.

Furthermore, conventional user interfaces for recipe recommendation tend to be static, offering one-shot suggestions without iterative refinement. When a user modifies conditions or provides additional feedback, existing systems often re-run the entire process from scratch with minimal reuse of prior computation, and without using machine learning results or generative model outputs to guide subsequent processing. This leads to redundant database operations, repeated feature computation, and inefficient utilization of processing capacity and memory resources, which is particularly problematic when handling large numbers of users or large recipe datasets. Accordingly, there is a need for an improved computer-implemented technique that: (i) accurately analyzes natural-language condition information from a user; (ii) converts such information into structured data suitable for high-quality database querying; (iii) integrates an ensemble decision-tree model or similar supervised learning algorithm to compute suitability scores for candidate cooking information; (iv) systematically generates prompt sentences for a generative artificial intelligence model based on the selected optimum cooking information and user conditions; and (v) supports iterative interaction by re-executing analysis, search, selection, and generative-model cooperation while reusing structured representations and ranking information. By addressing these issues at the level of how the processor processes data—through specific data structures, coordinated processing stages, and controlled interactions with a generative AI model—the present invention aims to improve the functioning of the computer system itself in terms of efficiency, scalability, stability of output, and quality of decision-making, rather than merely automating a human mental process.

The specific processing by the specific processing unit 290 of the data processing device 12 in Example 2 is realized by the following means.

The present invention provides a server comprising a processor and a memory storing instructions which, when executed by the processor, cause the processor to receive, via an interface including a display device and an input device, condition information expressed in natural language from a user, the condition information including ingredient information, time-condition information, preference information, and number-of-persons information; to analyze the received condition information by using a natural language processing technique including string processing and morphological analysis, to extract keywords indicating ingredient conditions, time conditions, number-of-persons conditions, and preference conditions from the condition information, and to normalize the extracted keywords as structured data; to search, based on the structured data, a data set stored in a storage device and including cooking information by using a query language, and to extract, as candidate cooking information, a plurality of cooking information records that satisfy the condition information; to numerically convert, for each piece of the candidate cooking information, attribute information including ingredient-match information, time-condition match information, preference-condition match information, provision-history information, and evaluation information into feature values, to calculate a suitability score for each piece of the candidate cooking information by using a supervised learning algorithm including an ensemble decision-tree model, and to select, based on the suitability scores, optimum cooking information; to generate, based on the optimum cooking information and the condition information, a prompt sentence for input to a generative artificial intelligence model, and to transmit the prompt sentence to the generative artificial intelligence model; to analyze response text received from the generative artificial intelligence model, to combine the response text with the optimum cooking information, and to edit the combined information as proposal information including recipe information, cooking-procedure information, variation information, and cooking-advice information to be presented to the user via the display device; and to acquire, via the interface, re-input information or condition-change information from the user, and to re-execute at least the analysis, search, selection, prompt-sentence generation, and communication with the generative artificial intelligence model based on the re-input information or the condition-change information so as to update the proposal information. This enables an improvement of the computer technology itself by providing a coordinated processing pipeline that transforms unstructured natural-language input into structured data, optimizes database retrieval and machine-learned ranking, and systematically controls interactions with a generative artificial intelligence model, thereby reducing redundant computation, stabilizing response quality, enhancing scalability for large data sets, and improving the efficiency and accuracy of recipe selection and presentation.

The term “processor” refers to a hardware computation element, such as a central processing unit or a processing core, configured to execute instructions for performing the operations described in the present disclosure.

The term “memory” refers to a non-transitory computer-readable storage medium, such as a semiconductor memory, magnetic storage, or optical storage, that stores instructions and data for use by the processor.

The term “interface” refers to a combination of hardware and software components, including input and output mechanisms, through which a user can provide information to the system and receive information from the system.

The term “display device” refers to an output apparatus, such as a flat-panel display, monitor, or screen of a portable terminal, configured to visually present information to a user.

The term “input device” refers to an apparatus, such as a touch panel, keyboard, pointing device, or microphone, through which a user can input data or commands to the system.

The term “user” refers to a human operator or an entity that provides condition information to the system and receives proposal information from the system.

The term “condition information” refers to information expressed in natural language by the user, including at least ingredient information, time-condition information, preference information, and number-of-persons information used for selecting cooking information.

The term “ingredient information” refers to information specifying food materials or components to be used or desired in cooking.

The term “time-condition information” refers to information indicating a temporal constraint related to cooking, such as a maximum allowable cooking time or desired preparation duration. The term “preference information” refers to information representing a user's subjective likes, dislikes, taste tendencies, or other qualitative requirements regarding cooking.

The term “number-of-persons information” refers to information indicating a quantity of persons for whom a dish is to be prepared or served.

The term “natural language processing technique” refers to a set of computational procedures for analyzing text expressed in human language, including operations such as tokenization, morphological analysis, part-of-speech tagging, and entity extraction.

The term “string processing” refers to operations on character sequences, including normalization, segmentation, pattern matching, and conversion used to prepare text for further analysis.

The term “morphological analysis” refers to a process of decomposing a sentence into morphemes, determining grammatical categories, and identifying word boundaries and base forms.

The term “keyword” refers to a unit of information extracted from condition information that represents a meaningful constraint, such as an ingredient condition, a time condition, a number-of-persons condition, or a preference condition.

The term “structured data” refers to data organized in a defined schema or format, such as key-value pairs, tables, or records, that can be directly used for database querying and machine learning processing.

The term “storage device” refers to a physical or logical data storage apparatus, such as a database server, disk subsystem, or cloud storage, configured to store cooking information and related data.

The term “data set” refers to a collection of related data records, such as multiple cooking information records, stored in the storage device and accessible via a query language.

The term “cooking information” refers to information related to a dish or recipe, including at least a recipe name, ingredient list, required time, number of servings, preparation steps, and optionally evaluation or history information.

The term “query language” refers to a formal language, such as a structured query language, used to specify retrieval conditions and operations on a data set stored in a storage device.

The term “candidate cooking information” refers to a plurality of cooking information records retrieved from the data set that satisfy or approximately satisfy the user's condition information.

The term “attribute information” refers to data associated with each piece of cooking information, including ingredient-match information, time-condition match information, preference-condition match information, provision-history information, and evaluation information.

The term “ingredient-match information” refers to information indicating a degree of correspondence between requested ingredient conditions and ingredients included in particular cooking information.

The term “time-condition match information” refers to information indicating a degree of compatibility between a requested time condition and a cooking time associated with particular cooking information.

The term “preference-condition match information” refers to information indicating a degree of compatibility between user preference information and characteristics of particular cooking information.

The term “provision-history information” refers to information indicating past provision or selection history of particular cooking information, such as frequency of use or ordering records.

The term “evaluation information” refers to information representing assessments or ratings of particular cooking information, such as user scores, reviews, or internal quality metrics.

The term “feature value” refers to a numerical representation of attribute information or other factors, used as an input element of a feature vector for machine learning processing.

The term “supervised learning algorithm” refers to a machine learning method that learns a mapping from input feature values to output labels or scores based on training data including input-output pairs.

The term “ensemble decision-tree model” refers to a supervised learning model that aggregates multiple decision trees, such as a random forest or gradient-boosted trees, to produce a prediction or score based on feature values.

The term “suitability score” refers to a quantitative value output by the supervised learning algorithm indicating a degree of appropriateness of candidate cooking information with respect to the user's condition information.

The term “optimum cooking information” refers to one or more pieces of cooking information selected from the candidate cooking information based on the suitability scores as best satisfying the user's condition information.

The term “prompt sentence” refers to a text string formulated to be input to a generative artificial intelligence model, the text string encoding the optimum cooking information, the condition information, and instructions for generating a response.

The term “generative artificial intelligence model” refers to a trained computational model, such as a large language model, configured to generate text or other content in response to an input prompt sentence.

The term “response text” refers to text output generated by the generative artificial intelligence model in response to a provided prompt sentence.

The term “proposal information” refers to information generated for presentation to the user, including at least recipe information, cooking-procedure information, variation information, and cooking-advice information.

The term “recipe information” refers to structured data describing a dish, including at least a title, ingredients, and quantities.

The term “cooking-procedure information” refers to information describing ordered steps or actions for preparing and cooking a dish.

The term “variation information” refers to information describing alternative versions, modifications, or substitutions for a base recipe or cooking procedure.

The term “cooking-advice information” refers to information providing hints, tips, or recommendations to improve cooking results, efficiency, or suitability to user preferences.

The term “re-input information” refers to information newly provided by the user after an initial proposal, including revised conditions or additional requests.

The term “condition-change information” refers to information indicating modifications of previously provided condition information, such as changes to ingredients, time limits, or number of persons.

The term “emotional state” refers to an inferred affective condition of the user, such as mood or emotional tendency, as analyzed or estimated based on input to or output from a generative artificial intelligence model.

The term “provision facility” refers to a service provider, such as a restaurant or prepared-food provider, capable of supplying a dish corresponding to cooking information.

The term “delivery service” refers to a service that transports prepared food from a provision facility or other source to a user-specified location.

The term “identification information for video content” refers to data, such as a uniform resource locator or an identifier, that enables access to video content describing a cooking method.

The term “shortened cooking-procedure information” refers to a condensed or summarized representation of cooking-procedure information including essential steps in a reduced amount of text.

In one embodiment, a server cooperates with one or more terminals operated by a user to implement a recipe recommendation and generation system. The server includes at least one processor, a main memory, a non-transitory storage device, a network interface, and access to a database system. The terminal includes at least a display device and an input device, and may be realized by a smartphone, a tablet computer, a notebook computer, or a desktop computer. The server and the terminal communicate via a communication network such as the Internet using a protocol such as HTTPS.

The server executes a program stored in the storage device and loaded into the main memory.

The program is implemented, for example, using a general-purpose programming language and a web application framework, and is configured to control data processing modules including a natural language processing module, a database access module, a machine learning scoring module, and a generative AI integration module.

The terminal provides a user interface implemented by a web browser or a native application.

The terminal displays input fields, selection components, and control buttons, and the user inputs condition information in natural language, such as ingredient information, time-condition information, preference information, and number-of-persons information. For example, the user may input text such as “Chicken, 30 minutes, 2 servings, Japanese” OR “I would like to know a Japanese dish for 2 that is light in flavor and can be made in less than 30 minutes using chicken.” The terminal converts the user input into a structured request and transmits it to the server via the network interface.

The server receives the request and stores the raw text and structured fields in working memory. The server uses a natural language processing library, such as an open-source natural language processing framework configured with a Japanese language model, to analyze the user's natural language input. The server executes string processing such as normalization of character encodings, unification of time units, and removal of extraneous symbols. The server then performs morphological analysis and part-of-speech tagging to segment the user's input into tokens and to identify candidate keywords.

The server uses named entity recognition and rule-based extraction to identify tokens or token spans corresponding to ingredient names, time expressions, serving numbers, taste preferences, and cuisine types. The server converts these tokens into normalized structured data, for example into a data structure including fields for ingredient list, maximum cooking time in minutes, number of persons, cuisine category, and a set of preference flags such as “light taste,” “spicy,” or “low salt.” In this way, the server transforms unstructured natural language into structured data suitable for database querying and machine learning processing. This transformation reduces ambiguity in user input and enables consistent interpretation of varied expressions, which improves accuracy and robustness compared to manual or rule-only systems.

The server accesses a relational database management system installed on a separate storage system or on the same server machine. The database stores cooking information records, each including at least a recipe identifier, recipe name, ingredients list, required time, number of servings, cuisine type, difficulty level, historical selection frequency, and rating values. The server uses a query language, such as a structured query language, to retrieve candidate cooking information records that satisfy or approximately satisfy the normalized condition information. The server constructs parameterized queries using the structured data fields and executes these queries against indexed tables in the database. By using indexed columns for ingredients, required time, and cuisine, the server reduces access time and disk I/O. The database engine returns a set of candidate records, which the server loads into memory as internal objects. The use of parameterized queries and indexes improves query execution time and reduces CPU load, thereby providing a technical advantage over naive full-table scanning or unparameterized query construction.

The server then invokes a machine learning scoring module implemented with a supervised learning algorithm, such as an ensemble decision-tree model (for example, a random forest or a gradient-boosted tree ensemble) provided by a machine learning library. The server loads a model file, previously trained and stored in the storage device, into memory. The model has been trained offline using training data that includes historical user interactions, recipe attributes, and target labels representing user satisfaction or selection outcomes.

The server converts each candidate cooking information record into a feature vector. The feature vector includes numeric and categorical features, such as: ingredient match ratio between requested ingredients and recipe ingredients; difference between requested time and recipe required time; binary or scalar indicators of taste profile match; cuisine type encoded as categorical features; historical selection frequency; average rating; variance of ratings; and indicators derived from textual descriptions using natural language processing, such as embedding-based similarity values. The server applies consistent scaling and encoding to the features based on parameters stored with the model. By representing each recipe as a feature vector of fixed dimension, the server enables efficient use of vectorized operations on the processor, improving throughput.

The server inputs the feature vectors into the ensemble decision-tree model, which outputs suitability scores. Internally, the ensemble model executes multiple decision trees, each performing a sequence of comparisons of feature values against learned thresholds and producing partial predictions. The server aggregates the outputs across the trees by averaging or summation, according to the ensemble configuration, to obtain a final suitability score for each candidate recipe. The server then selects one or more recipes with the highest suitability scores as optimum cooking information.

Because the ensemble model is trained with a loss function based on prediction error (for example, mean squared error or cross-entropy) and optimized via repeated weight updates (for example, adjustment of tree structures and split thresholds during training), the resulting model captures non-linear relationships among features that are difficult for human-designed rules to approximate. The use of such a model allows the server to automatically identify complex patterns in user preference, temporal constraints, and recipe attributes, leading to improved accuracy and reduced error rates in recipe selection compared to simple rule-based or manual scoring approaches.

The server then generates a prompt sentence for a generative AI model. The server uses a prompt generation module that takes as inputs the optimum cooking information and the structured condition information. The server constructs a template including explicit placeholders for recipe name, ingredient list, required time, number of servings, and preference details, and fills these placeholders with concrete data values. For example, the server may generate prompt sentences such as:
“Please suggest three Japanese recipes for two people that can be prepared in 30 minutes or less using chicken, detailing the ingredients, procedures, and cooking tips for each.” or
“Given the user conditions ‘chicken, 30 minutes, 2 servings, Japanese’, generate an easy-to-follow recipe with step-by-step instructions suitable for a beginner cook.” or
“Using the following selected recipe details, propose side dishes and a dessert that match Japanese cuisine and can be prepared in under 20 minutes: [here the server inserts the recipe name and ingredient list].”

The server thus generates prompt sentences that are directly tied to the selected optimum cooking information and structured user conditions, rather than generic or manually crafted prompts. This systematic prompt generation reduces variability in requests, leading to more consistent and targeted responses from the generative AI model and reducing computation time spent on irrelevant or overly broad generations.

The server transmits the generated prompt sentence to a generative AI model provided by a generative artificial intelligence service or hosted on a dedicated machine with specialized hardware such as graphics processing units. The generative AI model is implemented as a neural network with an encoder-decoder or transformer architecture. The model includes multiple layers of attention mechanisms, feed-forward networks, and normalization layers. The model parameters are trained in advance using large-scale text corpora, optimizing a loss function such as cross-entropy between predicted tokens and target tokens under stochastic gradient descent or related optimization algorithms.

The server formats the prompt sentence into the request format required by the generative AI model, such as a sequence of tokens or a structured message array, and sends it through an application programming interface. The generative AI model tokenizes the prompt, produces contextual embeddings for each token, propagates these embeddings through multiple attention layers and feed-forward layers, and computes probability distributions over output tokens step by step. The model then generates a response text sequence that includes recipe variations, detailed instructions, cooking tips, or side-dish suggestions in accordance with the given prompt sentence. The server receives the response text from the generative AI model and parses it. The server optionally segments the text into sections such as “Main Recipe,” “Variation 1,” “Variation 2,” and “Tips,” based on headings, delimiters, or heuristic rules. The server associates each segment with corresponding fields in an internal data structure, and combines this data with the original optimum cooking information from the database. The server edits the combined information into proposal information, which includes at least recipe information, cooking-procedure information, variation information, and cooking-advice information.

The terminal receives the proposal information as a structured response and formats it for display. The terminal displays the recipe name, a list of required ingredients with quantities, step-by-step cooking instructions, estimated cooking time, and the number of servings. The terminal further displays the AI-generated variations and tips in separate sections. The user can review the content and may choose a variation or modify conditions.

The server also supports iterative interaction. When the user changes condition information or inputs additional requests such as “Please make this recipe even lighter and suitable for children,” the terminal sends the updated information to the server. The server reuses previously computed structured data and may constrain the new search around previously selected recipes or features, reducing database query size and machine learning computation. The server then re-executes the pipeline of natural language analysis, structured data generation, database search, machine learning scoring, prompt generation, and generative AI invocation with the updated conditions.

By structuring the data flow into modular stages with specific data formats (raw text, tokens, structured condition objects, candidate recipe lists, feature vectors, suitability scores, prompt sentences, and response texts), the server optimizes internal memory usage, allows caching of intermediate results, and reduces redundant computation across iterations. For example, once a mapping from ingredient names to internal identifiers is computed, the server can store and reuse it for subsequent queries from the same session. Similarly, when multiple users request similar conditions, the server can reuse cached feature vectors or model outputs, reducing load on the machine learning module and the generative AI model.

The described architecture and processing pipeline improve computer technology in several ways. First, the combination of natural language processing and structured data normalization reduces parsing errors and supports efficient, index-based database access, which decreases query latency and CPU load. Second, the use of an ensemble decision-tree model and feature engineering for recipe ranking improves selection accuracy and reduces the need for repetitive user corrections, which decreases overall network traffic and interaction time. Third, the systematic generation of prompt sentences based on structured and ranked data leads to shorter, more focused prompts, reducing the number of tokens processed by the generative AI model and thereby decreasing computational cost and response time. Fourth, the iterative, stateful handling of user interactions with selective recomputation and caching lowers redundant processing load on the server and the database, improving scalability for large numbers of concurrent users. In contrast to merely automating a human decision process, the server performs machine-level optimizations such as vectorized feature computation, tree traversal in ensemble models, efficient indexing of recipe attributes, and token-level control of prompt and response size. These technical mechanisms allow the system to execute complex matching and generation tasks at a speed and scale not achievable by human operators, and with improved consistency and lower error rates compared to naive implementations that rely on unstructured text matching or ad hoc manual prompts.

In another embodiment, the server additionally generates a prompt sentence for analyzing an emotional state related to the optimum cooking information. The server incorporates user reaction signals, such as explicit feedback ratings or implicit signals like repeated selection or abandonment, into feature vectors used to train a secondary model that estimates an emotional state class or score. The server then constructs a prompt sentence describing the optimum recipe and requesting an evaluation of how well the recipe fits a particular emotional context. The generative AI model outputs text that the server parses to update internal emotional-state features. The server uses these features to adjust suitability scores in the ensemble model or to select different candidate sets for future recommendations. This feedback loop improves alignment between computational decisions and user-affective preferences, further reducing the need for manual correction and increasing satisfaction.

In still another embodiment, the server generates, based on the optimum cooking information, identification information for video content describing the cooking method, such as a resource locator or an internal content identifier stored in the database. The server generates shortened cooking-procedure information by applying text summarization techniques or rule-based condensation to the detailed instructions. The terminal displays a link or button associated with the video content and a concise summary of the steps, making it easier for the user to follow the recipe on limited screen space. When the user selects an option to order the dish from a provision facility or delivery service, the server uses structured recipe identifiers and user location information to interface with external ordering systems, although such ordering is implemented at the communication protocol and data mapping level rather than as a mere business rule. Alternative embodiments may vary in the choice of natural language processing library, database implementation, machine learning algorithm, or generative AI model architecture. For example, the server may use a different morphological analyzer, a key-value store or a graph database, a gradient-boosted tree ensemble or a neural network ranking model, and a different transformer-based language model. However, in each case, the server maintains the essential operations of converting natural language to structured data, efficiently querying recipe data, computing suitability scores using supervised learning on defined feature vectors, generating prompt sentences tied to optimum cooking information, and integrating generative AI responses into structured proposal information. By doing so, each variation continues to improve the functioning of the computer system in terms of processing efficiency, scalability, and accuracy of recipe selection and presentation.

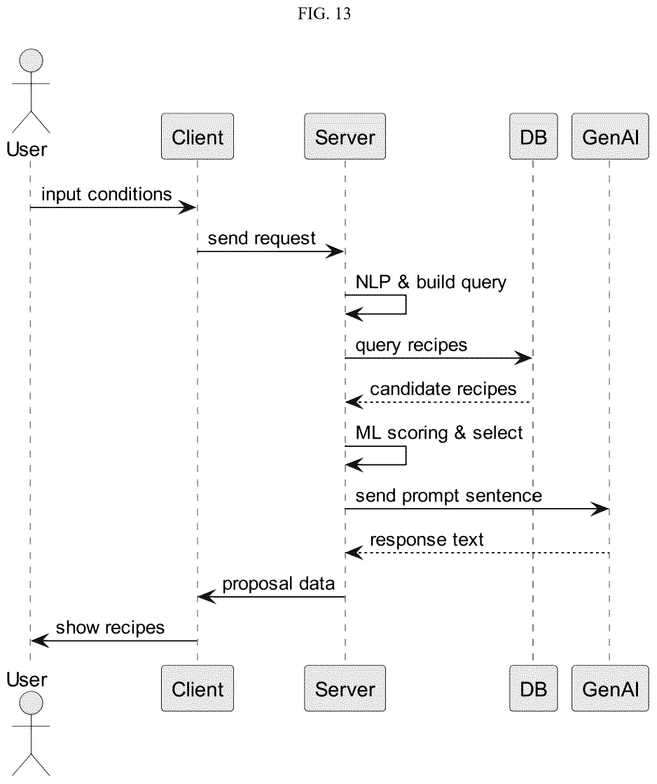

The following describes the processing flow using FIG. 13.

### Step 1:

The terminal displays an input screen for condition information.

The terminal shows text input fields and selection components for ingredient information, time-condition information, preference information, and number-of-persons information. The user inputs natural-language text such as “Chicken, 30 minutes, 2 servings, Japanese” OR “I would like to know a Japanese dish for 2 that is light in flavor and can be made in less than 30 minutes using chicken.” The terminal receives these values as raw text strings and simple structured values (for example, numbers selected from drop-down menus).

Input: user-entered natural-language text and UI selections.

Output: a structured request object including raw text fields and basic numeric fields (for example, JSON with keys such as ‘raw_text’, ‘time_limit’, ‘servings’).

### Step 2:

The terminal transmits the structured request to the server.

The terminal serializes the request object into a network message, attaches metadata such as a timestamp and session identifier, and sends the message to the server over a secure communication channel (for example, HTTPS).

Input: structured request object containing user condition information.

Output: an HTTP or similar network request delivered to the server containing the serialized condition information.

### Step 3:

The server receives and validates the request.

The server parses the incoming network request, extracts the body data, and checks for required fields (such as ingredient information and at least one time or servings constraint). The server rejects malformed input or applies default values if optional fields are missing. The server logs the request for monitoring.

Input: serialized network request from the terminal.

Output: an internal data structure in memory representing the condition information, including raw text and parsed primitive fields.

### Step 4:

The server performs text normalization and pre-processing.

The server converts full-width characters to half-width where appropriate, normalizes whitespace, unifies time expressions (for example, “30 minutes (in Japanese)” to “30 minutes”), and removes control characters. The server concatenates relevant free-text fields into a single string when beneficial for analysis.

Input: internal data structure containing raw user text.

Output: a cleaned and normalized text string ready for natural language processing, together with associated numeric fields.

### Step 5:

The server executes natural language processing to extract keywords.

The server applies a natural language processing pipeline including tokenization, morphological analysis, and part-of-speech tagging to the normalized text. The server identifies tokens likely to represent ingredients, time expressions, number-of-persons expressions, taste expressions, and cuisine categories. The server applies pattern rules and dictionaries to disambiguate similar tokens and map them to canonical forms (for example, mapping synonyms of “chicken” to a single ingredient identifier).

Input: normalized text string and auxiliary numeric fields.

Output: a set of extracted keywords and their canonical representations, such as ingredient list, maximum time in minutes, number of persons, preference tags, and cuisine type, stored as structured data.

### Step 6:

The server constructs a structured condition object.

The server aggregates the extracted keywords into a condition object with named fields (for example, ‘ingredients=[“chicken”]’, ‘max_time_minutes=30’, ‘servings=2’, cuisine=“Japanese”’, ‘taste_profile=“light”’). The server validates and resolves conflicts (for example, if multiple time expressions are detected, the server selects the strictest constraint).

Input: set of extracted keywords and canonical forms.

Output: a normalized condition object suitable for database querying and feature generation.

### Step 7:

The server formulates a database query based on the condition object.

The server maps the condition fields to database column names, constructs parameterized query clauses (for example, ‘ingredients_text LIKE?’, ‘required_time<=?’, ‘servings=?’, cuisine=?’), and prepares a query statement. The server uses indexes defined on key columns to plan efficient access.

Input: normalized condition object.

Output: a parameterized database query (for example, an SQL statement with bound parameters).

### Step 8:

The server executes the database query and retrieves candidate recipes.

The server sends the query to the database engine, which uses its query planner and indexes to scan relevant records. The server receives multiple rows representing candidate cooking information that satisfy or approximately satisfy the conditions. The server converts each row into an internal recipe object containing identifiers, attributes, and text fields.

Input: parameterized database query.

Output: a list or array of candidate recipe objects loaded into server memory.

### Step 9:

The server filters and prepares candidate recipes for feature computation.

The server removes candidates that fail hard constraints (for example, recipes with required time strictly greater than the allowed maximum). The server ensures that each remaining recipe has all required attributes (ingredients list, time, servings, ratings), and fills missing values with defaults where necessary. The server standardizes text fields (for example, lowercasing or normalizing ingredient lists) for consistent comparison.

Input: list of candidate recipe objects.

Output: a cleaned list of candidate recipe objects ready for feature extraction.

### Step 10:

The server generates feature vectors from candidate recipes.

The server computes numeric feature values such as ingredient match ratio, time difference, match indicators for taste profile and cuisine, historical selection frequency, average rating, and rating variance. The server encodes categorical variables (for example, cuisine type, difficulty) using predetermined schemes such as one-hot encoding or integer encoding. The server concatenates these values into fixed-length feature vectors aligned with the training configuration of the machine learning model.

Input: cleaned list of candidate recipe objects and normalized condition object.

Output: a corresponding list of feature vectors, each associated with a candidate recipe identifier.

### Step 11:

The server loads and applies an ensemble decision-tree model to compute suitability scores.

The server loads a pre-trained ensemble model (for example, a random forest) from storage into memory if not already loaded. The server inputs each feature vector into the model, which propagates the values through multiple decision trees, performing comparisons with learned thresholds at each node and aggregating results across trees. The server computes a suitability score for each candidate recipe, typically a probability or continuous score indicating match quality.

Input: list of feature vectors.

Output: a list of suitability scores aligned with the candidate recipes.

### Step 12:

The server selects optimum cooking information based on suitability scores.

The server sorts candidate recipes by descending suitability score and selects at least one top-ranked recipe as optimum cooking information. The server may also retain a set of top-N recipes for use in alternative suggestions. The server packages the selected recipe's attributes and detailed instructions into an internal structure for later use in prompt generation and presentation.

Input: list of candidate recipe objects and corresponding suitability scores.

Output: one or more optimum recipe objects with their associated scores.

### Step 13:

The server generates a prompt sentence for a generative AI model.

The server uses the optimum recipe object and the condition object to fill a prompt template. The server includes explicit fields such as ingredient names, number of servings, time limit, cuisine type, and any preference tags, as well as the textual recipe steps when appropriate. The server produces prompt sentences, for example:
“Please suggest three Japanese recipes for two people that can be prepared in 30 minutes or less using chicken, detailing the ingredients, procedures, and cooking tips for each.”
or
“Given the user conditions ‘chicken, 30 minutes, 2 servings, Japanese’, generate an easy-to-follow recipe with step-by-step instructions suitable for a beginner cook.”

Input: optimum recipe object and normalized condition object.

Output: one or more prompt sentences formatted as text strings suitable for input to a generative AI model.

### Step 14:

The server transmits the prompt sentence to the generative AI model and obtains response text. The server converts the prompt sentence into the API-specific request format, such as a sequence of tokens or a message structure, and sends it to the generative AI model via a network interface. The generative AI model processes the prompt and returns generated text, which the server receives and stores in memory.

Input: prompt sentence text.

Output: response text generated by the generative AI model, typically including recipe variations, detailed instructions, or cooking tips.

### Step 15:

The server integrates the response text with the optimum recipe information.

The server parses the response text to identify logical segments (for example, main recipe, variations, tips) using delimiters, headings, or heuristic rules. The server associates each segment with corresponding fields in a proposal structure and combines these with the original optimum recipe data from the database.

Input: response text from the generative AI model and optimum recipe object.

Output: a proposal information object including recipe information, cooking-procedure information, variation information, and cooking-advice information.

### Step 16:

The server formats and sends proposal information to the terminal.

The server converts the proposal information object into a structured response format (for example, JSON), ensuring that all necessary fields (title, ingredients, steps, time, servings, variations, tips) are included. The server sends this response to the terminal over the network.

Input: proposal information object.

Output: serialized response data delivered to the terminal.

### Step 17:

The terminal displays the proposal information to the user.

The terminal parses the response data and renders the main recipe details, ingredient lists, and step-by-step instructions on the display device. The terminal also renders sections for variations and cooking advice, possibly with collapsible panels or tabs. The user visually inspects the content and may scroll, switch sections, or select options.

Input: serialized response data from the server.

Output: visual presentation of proposal information on the terminal display.

### Step 18:

The user evaluates the proposal and optionally modifies conditions or requests further refinement.

The user reviews the presented recipes and AI-generated suggestions and decides whether additional changes are needed, such as modifying the time limit, increasing the number of persons, or requesting healthier or child-friendly options. The user inputs new text such as “Make this recipe lighter and suitable for children” or adjusts UI controls for time and servings.

Input: displayed proposal information and user preferences.

Output: updated user input indicating re-input information or condition-change information.

### Step 19:

The terminal sends updated condition or refinement requests to the server.

The terminal packages the new user input together with session identifiers and, if applicable, identifiers of previously selected recipes. The terminal sends these updated conditions to the server in the same manner as in the initial request.

Input: updated user input indicating changes or refinements.

Output: a new structured request delivered to the server.

### Step 20:

The server re-executes key processing stages to update the proposal information.

The server receives the updated request and determines which parts of the pipeline must be recomputed. The server may reuse prior structured condition objects or feature vectors when the change is partial, or recompute natural language analysis, database search, machine learning scoring, and prompt generation when the change is substantial. The server then obtains a new optimum recipe set, generates new prompt sentences, receives new response text from the generative AI model, and constructs updated proposal information.

Input: updated structured request containing re-input information or condition-change information.

Output: new or revised proposal information object, which is again sent to the terminal for display.

### Application Example 2

Description follows regarding a flow of the specific processing in an Application Example 2. The units of the system described below are implemented by the data processing device 12 and the smart device 14. The data processing device 12 is called a “server” and the smart device 14 is called a “terminal”.

Conventional recipe recommendation and food ordering systems typically separate multiple processing layers such as user-preference analysis, emotion analysis, content retrieval, and ordering functions. In many existing systems, these functions are implemented as loosely coupled modules or manual workflows, which leads to several technical problems from the standpoint of computer technology.

First, conventional systems generally treat user inputs as a set of static parameters and do not consistently perform structured natural-language preprocessing and emotion-aware prompt generation for a generative AI model on the server side. As a result, the server often cannot exploit rich free-text input, user history, and emotional state in a unified way, and must instead rely on simplistic rule-based filtering. This causes inefficient utilization of computing resources, because large amounts of potentially useful user data are not encoded into a machine-processable form suitable for downstream models.

Second, conventional systems usually implement recommendation logic and content retrieval as separate pipelines. A typical server computes candidate items based only on static attributes in a database, then independently searches for related videos or external content. The absence of a common feature representation and ranking process across candidate dishes, video links, and ordering options leads to redundant database queries and external API calls. This can increase latency, network traffic, and processor load when generating personalized outputs for each session.

Third, known architectures do not tightly integrate a generative AI model as a central component for both emotion analysis and content generation. In many systems, emotion recognition is performed by a dedicated external service, while summarization and explanation generation are either absent or handled by simple template engines. Such fragmentation prevents the system from generating optimized prompt sentences that jointly encode user conditions, emotion states, and candidate attributes, and from reusing the same generative model to drive ranking, explanation, and summarization. This results in suboptimal model performance and makes it difficult to adapt the system to changing user behavior without extensive manual reconfiguration. Fourth, conventional systems often lack a robust, server-side, learning-based ranking mechanism that incorporates emotion features and history features into a common feature vector for each candidate dish. Without such a unified feature representation and trained numerical analysis model, the recommendation and optimization logic becomes rule-based and brittle. This can significantly degrade system performance under high load, because rule-based logic does not scale well with large candidate sets, and cannot exploit precomputed weights learned from historical interactions to produce efficient, high-quality rankings.

Fifth, existing systems typically do not perform systematic personalization of prompt sentences and generation conditions based on aggregated user histories. Even if a generative AI model is present, it is often invoked with generic prompts that ignore past selections, viewing behavior, and emotion patterns. This causes repetitive and poorly targeted prompts, leading to unnecessary calls to the model, longer inference times, and inefficient usage of computational resources. Accordingly, there is a need for an improved computer-implemented system and server architecture that: (i) transforms heterogeneous user input (including free-text and emotion-related information) into structured data and optimized prompt sentences; (ii) employs a trained numerical analysis model to compute feature-based evaluation values for candidate dishes; (iii) coordinates a generative AI model for emotion analysis, recommendation refinement, explanation generation, and summarization; and (iv) personalizes both the prompt generation and candidate-generation conditions based on accumulated history. Such a system should reduce redundant processing, decrease response time, and increase the technical efficiency and quality of personalized outputs in a recipe recommendation and ordering environment.

The specific processing by the specific processing unit 290 of the data processing device 12 in Application Example 2 is realized by the following means.

The present invention provides a server comprising a processor configured to (i) acquire, via an information input/output device, ingredient information, required time information, preference information, number-of-persons information, and free description information from a user; (ii) execute character-string analysis processing on the acquired information to generate structured data for the ingredient information, the required time information, the preference information, and the number-of-persons information and to extract emotion-related terms from the free description information; (iii) generate a prompt sentence for a generative AI model on the basis of the structured data and the free description information, and input the prompt sentence to the generative AI model so as to cause the generative AI model to output an emotion analysis result including an emotional state of the user and cooking candidate information; (iv) generate a plurality of candidate dishes as presentation data on the basis of the emotion analysis result and the structured data, calculate feature values for each candidate dish including at least a required-time parameter, an ingredient-matching degree, a preference-matching degree, a past-selection-history parameter, and an emotion parameter, and calculate, by using a trained numerical analysis model, an evaluation value for each candidate dish and rank the candidate dishes based on the evaluation values; (v) transmit data representing the ranked candidate dishes to the information input/output device and acquire dish identification information of a selected dish from the user; (vi) search a storage device based on the dish identification information to obtain cooking procedure information for the selected dish, transmit a search request to an external information providing device associated with a video distribution service, obtain reference information of a video representing a cooking procedure of the selected dish, and generate video link information; (vii) input the cooking procedure information to the generative AI model or to a character-string summarization process to generate summarized procedure information comprising a sequence of short procedure sentences as a summarized cooking procedure; (viii) search, based on at least location information and dish attribute information, a facility information storage device or an external facility search device to specify a food service facility or a delivery service corresponding to the selected dish and generate order support information; (ix) transmit the video link information, the summarized procedure information, and the order support information to the information input/output device for output; and (x) store, as history information, at least one of an input history, a selection history, a viewing history, and the emotion analysis result of the user, and perform personalization processing to update at least one of the prompt sentence and generation conditions of the plurality of candidate dishes based on the history information. This enables the server to improve computer-implemented recommendation and content-delivery performance by unifying natural-language preprocessing, emotion-aware prompt generation, feature-based ranking, generative-model-driven explanation and summarization, and history-based personalization in a single optimized processing pipeline, thereby reducing redundant computation and latency while enhancing the technical quality and relevance of outputs provided to the user.

The term “processor” refers to a hardware or virtual processing unit, such as a central processing unit or a set of processing circuits implemented in one or more machines, that executes instructions to perform the described operations.

The term “information input/output device” refers to any user-facing apparatus, such as a terminal, client device, display device, or combined input and display unit, that enables a user to input information to the server and receive output information from the server.

The term “ingredient information” refers to data indicating one or more materials used for preparing food or a dish, which may be entered by a user as text, selection items, or other input forms.

The term “required time information” refers to data indicating a time constraint or desired time period for preparing or obtaining a dish.

The term “preference information” refers to data indicating a user's taste, style, or other subjective choice criteria for dishes, such as spiciness level, cuisine type, or health orientation.

The term “number-of-persons information” refers to data indicating a count of persons to be served by a dish.

The term “free description information” refers to unstructured or partially structured user-entered text or speech content that is not limited to predefined categories and may include emotional expressions, context, or additional requirements.

The term “character-string analysis processing” refers to processing for analyzing text data, including at least tokenization, morphological analysis, syntactic analysis, entity extraction, or similar operations for converting text into structured representations.

The term “structured data” refers to data that is organized into defined fields or attributes according to a predetermined schema or data model, enabling machine processing such as querying, ranking, or model input.

The term “emotion-related terms” refers to words, phrases, or expressions extracted from user input that are indicative of a user's emotional state, such as terms associated with fatigue, stress, joy, or sadness.

The term “prompt sentence” refers to a natural-language text sequence generated for input to a generative AI model, the text sequence encoding user conditions, context, or instructions that cause the model to perform a specified processing task.

The term “generative AI model” refers to a trained computational model that receives a prompt sentence or other input data and generates new data, such as text or content, based on learned patterns, and includes at least generative language models.

The term “emotion analysis result” refers to output information indicating a user's emotional state or a distribution of emotional categories, derived by processing user data with a generative AI model or an emotion recognition model.

The term “cooking candidate information” refers to data describing one or more potential dishes or recipes suitable for a user, including at least identifiers, names, or attributes of candidate dishes.

The term “candidate dish” refers to a dish or recipe instance that has been selected or generated as a potential recommendation for a user based on input conditions and analysis results.

The term “presentation data” refers to data formatted for display or other output on an information input/output device, including dish names, attributes, explanations, and other user-visible or user-audible elements.

The term “feature value” refers to a numeric or categorical parameter representing a property of a candidate dish, a user state, or a contextual condition, which is used as an input dimension to a numerical analysis model.

The term “required-time parameter” refers to a feature value describing a relationship between a user's required time and the preparation time of a candidate dish.

The term “ingredient-matching degree” refers to a feature value indicating a degree of correspondence between ingredients available or desired by the user and ingredients required by a candidate dish.

The term “preference-matching degree” refers to a feature value indicating a degree of correspondence between the user's preference information and attributes of a candidate dish.

The term “past-selection-history parameter” refers to a feature value derived from historical records of dishes previously selected or used by the user.

The term “emotion parameter” refers to a feature value derived from the emotion analysis result and representing the influence of the user's emotional state on candidate selection.

The term “trained numerical analysis model” refers to a machine-learning or statistical model that has been trained on data to map feature values of candidate dishes and user context to evaluation values or scores.

The term “evaluation value” refers to a score or numerical measure produced by a trained numerical analysis model, representing a suitability or recommendation strength of a candidate dish for a user.

The term “dish identification information” refers to data, such as an identifier, code, or index, used to uniquely identify a dish in a storage device or database.

The term “storage device” refers to a memory or persistent data store, including but not limited to a database system or file system, that stores dish information, user histories, or facility information.

The term “cooking procedure information” refers to data describing steps or instructions for preparing a dish, including at least a sequence of actions, ingredient usage, and timing.

The term “external information providing device” refers to a system or service accessible via a communication network that provides content such as videos, metadata, or related information upon request.

The term “video distribution service” refers to a network-based service that stores and delivers video content in response to search or access requests.

The term “reference information” refers to data, such as a resource identifier or metadata, that specifies a video or other external content associated with a cooking procedure.

The term “video link information” refers to data describing an access path to a video resource, such as a uniform resource locator or other link that enables retrieval or playback of the video.

The term “character-string summarization process” refers to processing that reduces text length and complexity by extracting or generating shorter text that preserves key information from original text.

The term “summarized procedure information” refers to a shortened representation of cooking procedure information, typically as a sequence of brief procedure sentences that capture essential steps.

The term “dish attribute information” refers to data describing properties of a dish, such as cuisine type, difficulty, nutritional characteristics, or style category.

The term “facility information storage device” refers to a storage component that holds data about food service facilities or delivery services, including names, locations, and service attributes.

The term “external facility search device” refers to a system or service that receives search queries and returns information about facilities, such as restaurants or delivery providers, based on the queries.

The term “food service facility” refers to an entity that prepares and provides dishes to users, such as a restaurant or other eating establishment.

The term “delivery service” refers to an entity or system that transports dishes or food items from a food service facility or kitchen to a user's location.

The term “order support information” refers to data that assists a user in placing an order, including at least facility identification, menu information, pricing, and parameters needed for order creation.

The term “input history” refers to recorded data of past user inputs, including ingredient information, required time information, preference information, number-of-persons information, and free description information.

The term “selection history” refers to recorded data of dishes or options chosen by a user in past interactions.

The term “viewing history” refers to recorded data of content, such as videos or summaries, that the user has accessed or viewed.

The term “history information” refers to a collection of records including at least one of input history, selection history, viewing history, and emotion analysis results related to a user.

The term “personalization processing” refers to processing that modifies model inputs, prompt sentences, ranking conditions, or generation conditions on the basis of history information to tailor outputs to an individual user.

The term “preference feature” refers to a representation, usually numeric or categorical, that summarizes aspects of a user's preferences as derived from current input and history information.

The term “attribute information regarding the plurality of candidate dishes” refers to data describing properties of each candidate dish, including at least time, ingredient, category, and difficulty attributes.

The term “explanation sentence” refers to a text generated by a generative AI model that describes a reason or rationale for recommending a particular candidate dish.

The term “emotional-response category” refers to a classification that associates dishes or outputs with an intended emotional effect, such as simplifying cooking, enhancing celebration, or inducing calmness.

The term “weight of an emotional-response category” refers to a numerical coefficient that adjusts the contribution of a particular emotional-response category to feature values or model inputs.

The term “emotional state of the user” refers to a condition or mood of the user, such as stress, fatigue, joy, or sadness, as determined by emotion analysis processing.

In the following embodiments, a server, a terminal, and a user cooperate to implement the claimed system. The same reference architecture can be realized on various hardware and software platforms, as described below. The description supports and exemplifies the scope of the claims but does not limit the invention thereto.

### 1. Overall System Architecture

Server executes a recipe recommendation and ordering application on one or more computing devices. In one embodiment, server runs on a cloud computing environment, such as a virtual machine instance or container cluster, including at least a central processing unit, a main memory, a non-volatile storage device, and a network interface. Server executes an operating system such as a general-purpose server operating system, and a server application implemented in a programming language such as a scripting language or a compiled language.

Terminal operates as an information input/output device and can be realized by a smartphone, tablet, personal computer, or dedicated appliance. Terminal includes at least a display unit, an input unit such as a touch panel or keyboard, a camera, a microphone, a speaker, a local processor, and a communication interface. Terminal executes an operating system, a browser or native application framework, and an application program providing a graphical user interface for the described functions.

User operates terminal to input information and to consume outputs such as recommended dishes, video links, summarized cooking procedures, and order support information.

### 2. Data Structures and Storage

Server stores data in a database subsystem. In one embodiment, server uses a relational database management system, such as a common relational database, to store recipe data, user data, facility data, and history data.

Server stores recipe data in a table having, for example, fields such as: recipe_id, name, ingredients_json, cooking_time_minutes, tags_json, procedure_text, nutrition_json, and emotion_tags. The ingredients_json field stores an array of ingredient tokens, and tags_json stores attributes such as cuisine type, difficulty level, and taste category. The emotion_tags field stores tags such as “comfort,” “celebration,” or “calming.”

Server stores user history in a table having fields such as: user_id, timestamp, input_vector, selected_recipe_id, emotion_state, viewed_video_id, and outcome_flag. The input_vector field stores an array of feature values associated with a past session.

Server stores facility data in a table having fields such as: facility_id, name, location_coordinates, menu_keywords, and delivery_options_json. Server can additionally access an external facility information store via an application programming interface to supplement this data.

Server stores trained model parameters for a numerical analysis model and for a generative AI model in a storage module accessible to the application logic. In one embodiment, the generative AI model itself is provided as an external service, and server stores identifiers and configuration parameters for that model.

### 3. Natural-Language Preprocessing and Feature Extraction

Server performs character-string analysis processing on text input from user. Server loads libraries for natural-language processing, such as a tokenization and part-of-speech tagging library, into main memory and executes them on the processor.

Server converts user free description information into a sequence of tokens, applies part-of-speech tagging, and performs lemmatization. Server then applies a rule-based pattern matcher and a sentiment lexicon to extract emotion-related terms. For example, server maps phrases such as “I am tired,” “I feel exhausted,” and “too busy today” into an emotion indicator “fatigue.”

Server converts structured input items (ingredients, required time, preference, number of persons) into canonical forms. Server normalizes ingredient strings into canonical ingredient identifiers by comparing tokens against a dictionary and by optionally using an embedding-based similarity function. Server thus transforms raw text into a vector of discrete identifiers.

Server concatenates the following into a feature vector for each session: normalized ingredient identifiers, required time as a numeric value, preference categories as one-hot or multi-hot vectors, number of persons as a numeric feature, emotion indicators as one-hot or multi-hot vectors, and optionally additional context such as time-of-day or device type. Server stores this feature vector as input_vector in the user history table.

This explicit feature extraction and structuring reduces downstream model complexity and enables efficient indexing and caching of queries, thereby improving processing speed and enabling consistent handling of free-text information that is not feasible with simple rule-based systems.

### 4. Generative AI Model Integration and Prompt Generation

Server integrates a generative AI model as a central component for multiple tasks. In one embodiment, the generative AI model is a transformer-based language model with multiple self-attention layers, layer normalization, and feedforward sublayers, trained on large corpora of natural language data. The model receives a prompt sentence and outputs a natural-language sequence.

Server generates a prompt sentence by concatenating descriptive segments encoding structured user conditions, extracted emotion, and candidate dish attributes into a single natural-language text. In one embodiment, server generates a prompt sentence such as:
“User conditions: ingredients=chicken, onion, tomato; required time=30 minutes; preference=spicy; people=2.

User emotion: tired.

Based on these conditions, select the best recipe from the following candidates and briefly explain why it suits the user's emotion:
1) Spicy Chicken Curry
2) Simple Chicken Tomato Stir-fry.”

Server submits this prompt sentence to the generative AI model via a network request, receives the resulting text, and parses the name of the recommended dish and the explanation portion.

Server then adds the explanation as metadata to the candidate dish presentation data.

Server also generates summarization prompt sentences using the full procedure_text of a recipe. For example, server can generate:
“Summarize the following detailed recipe instructions into 4 short, numbered steps that are easy to follow while cooking. Focus on the main actions and omit unnecessary detail.
[full recipe text]”

Server then sends this prompt sentence and the procedure text to the generative AI model and receives summarized procedure information as a sequence of short sentences.

By structuring input to the generative AI model through these prompt sentences, server ensures that the model operates under consistent conditions and produces output that can be deterministically parsed and integrated into the data pipeline, which enhances system robustness and reduces post-processing complexity.

### 5. Numerical Analysis Model for Ranking

Server implements a trained numerical analysis model to compute evaluation values for candidate dishes. In one embodiment, the numerical analysis model is a feedforward neural network with one or more hidden layers. Each hidden layer applies an affine transformation followed by an activation function such as a rectified linear unit. The output layer produces a scalar value representing the evaluation value.

Server trains this numerical analysis model offline using historical user interactions. Server constructs training samples by associating input feature vectors for presented candidate dishes with labels derived from user behavior, such as selection events, completion flags, or ratings.

Server defines a loss function, such as a mean squared error between predicted evaluation values and target scores derived from historical outcomes, or a cross-entropy loss for pairwise ranking.

Server executes an optimization algorithm such as stochastic gradient descent or an adaptive method to update the network weights.

Server periodically retrains or fine-tunes the model with newly accumulated history data and updates the stored model parameters. Because the model represents evaluation values as continuous outputs based on feature vectors, server can compute scores for many candidates in parallel, which improves scalability compared to a purely rule-based approach.

During operation, server uses this numerical analysis model to convert each candidate dish's feature values into an evaluation value. Server then sorts candidates by evaluation values and selects top entries. This ranking process reduces the number of items passed to the generative AI model for refinement, thereby reducing model invocation cost and overall latency.

### 6. Emotion-Aware Weighting and Personalization

Server uses the emotion analysis result not only as descriptive information but also as a numerical factor in feature vectors and prompt sentences. Server defines emotional-response categories, such as simple cooking, celebratory cooking, and calming cooking, and assigns weights to these categories based on the current emotion state.

For instance, if emotion_state=“tired,” server increases the weight of the simple cooking category and decreases the weight of celebratory cooking. Server includes these weights as features in the numerical analysis model input. Additionally, server uses them to select or filter video links and to adjust the style of summarization prompts.

Server stores history information including past emotion states, selected recipes, and viewed videos. Over time, server computes preference features, such as the probability that a user chooses spicy dishes when fatigued, or the probability that a user watches a video longer than a certain duration. Server incorporates these preference features into prompt sentences, for example:
“User usually chooses simple spicy chicken dishes when tired. Please propose 3 new similar recipes using today's ingredients: chicken, onion, tomato.”

This personalization processing ensures that both the ranking model and the generative AI model receive inputs that encode long-term behavioral patterns, which improves recommendation precision and reduces the number of iterations needed to converge on suitable suggestions.

### 7. Video Retrieval and Integration with External Services

Server integrates with an external video distribution service to retrieve videos corresponding to selected dishes. Server builds search queries based on dish names, tags, and emotion-related attributes. For example, server may generate:
“spicy chicken curry easy 30 minutes home cooking”

Server transmits this query through an external information providing device interface, receives a list of video items with metadata, and selects a video according to matching criteria such as title similarity, duration, and popularity.

Server then generates video link information, such as a uniform resource locator, and associates it with the recipe. Server sends this link to terminal, which causes playback in a web view or external application. Because server filters and selects video links based on both structured recipe attributes and emotion-aware weights, the system achieves improved relevance and reduces the need for user searches over large video catalogs.

### 8. Facility Search and Order Support

Server cooperates with external facility search devices to identify food service facilities or delivery services that can provide the selected dish. Server transmits search parameters including approximate dish name, cuisine type, and user location coordinates. The external device returns candidate facilities, and server filters these facilities using string matching against menu_keywords and similarity scoring.

Server builds order support information containing facility identifiers, estimated delivery times, and price information, and sends this information to terminal. Terminal then presents interactive elements enabling user to confirm an order. In this configuration, the same feature representation and emotion-aware preferences that guided recipe generation can be used to prioritize facilities, such as choosing facilities associated with comfort food when the user is fatigued.

### 9. Technical Effects and Improvement of Computer Technology

Server, by structuring natural-language input into feature vectors and optimized prompt sentences and by combining a trained numerical analysis model with a generative AI model, improves the operation of the computer system itself in several technical dimensions.

First, server reduces computational and communication load by using the numerical analysis model to pre-rank candidates before invoking the generative AI model. This design reduces the number of expensive generative model calls and enables efficient use of processor and network resources.

Second, server encodes rich emotional and preference information into compact feature vectors and prompt structures, which improves the ability of both the ranking model and the generative model to discriminate between candidates. This leads to improved precision of first-pass suggestions, reducing the number of iterative interactions and thereby improving response time. Third, server uses structured history information to adapt model inputs and prompt sentences. This personalization directly affects cache hit rates for repeated queries and allows precomputation of partial results for recurring patterns, which reduces latency and energy consumption at the server side.

Fourth, server's use of emotion-aware weighting in feature vectors yields a non-trivial adjustment of ranking compared to simple rule-based filtering. This adjustment uses non-linear transformations applied by the neural network to combine emotion parameters with other features, yielding evaluation values that cannot be easily replicated by manual heuristics. This reduces error rates in matching user states to suitable dishes and content.

Fifth, by centralizing multiple functions—emotion analysis, candidate generation, explanation generation, and summarization—around a single generative AI model interfaced via structured prompt sentences, server minimizes the number of disparate models and services that must be orchestrated. This simplification improves reliability and maintainability of the overall pipeline, which is a technical benefit for complex distributed systems.

These improvements are rooted in specific data structures (feature vectors, history records, prompt sentences) and concrete algorithmic flows (NLP preprocessing, neural network ranking, generative summarization), and they result in quantifiable enhancements in processing speed, relevance precision, and resource usage, rather than in mere automation of human decision-making.

### 10. Alternative Embodiments

Server can be implemented using different model architectures. In a first alternative embodiment, server replaces the feedforward ranking network with a gradient boosting decision tree model, while preserving the same feature vector format. In a second alternative embodiment, server deploys the generative AI model locally instead of using an external service and can adjust internal parameters such as the number of layers, hidden dimension size, and sampling temperature.

Server can vary the natural-language processing pipeline by using different tokenization schemes or embedding models, provided that the feature vector still encodes ingredients, time, preferences, persons, and emotion indicators. Server can also apply different loss functions during training, such as pairwise ranking loss for comparing clicked and non-clicked candidates, to further refine evaluation values.

Terminal can take various forms. In one embodiment, terminal is a mobile device running a native application. In another embodiment, terminal is a web browser rendering a web application, communicating with server through an application programming interface. Terminal can optionally perform local preprocessing, such as compressing video metadata or caching recipe images, to reduce network load.

User can interact with the system via voice instead of text, in which case terminal performs speech recognition and sends transcribed free description information to server. The subsequent processing on server remains the same.

In each of these embodiments, server, terminal, and user cooperate to perform the claimed functions, and the described data structures, models, and processing flows provide a concrete and technically improved implementation of emotion-aware recipe recommendation, content delivery, and ordering support using a generative AI model and prompt sentences.

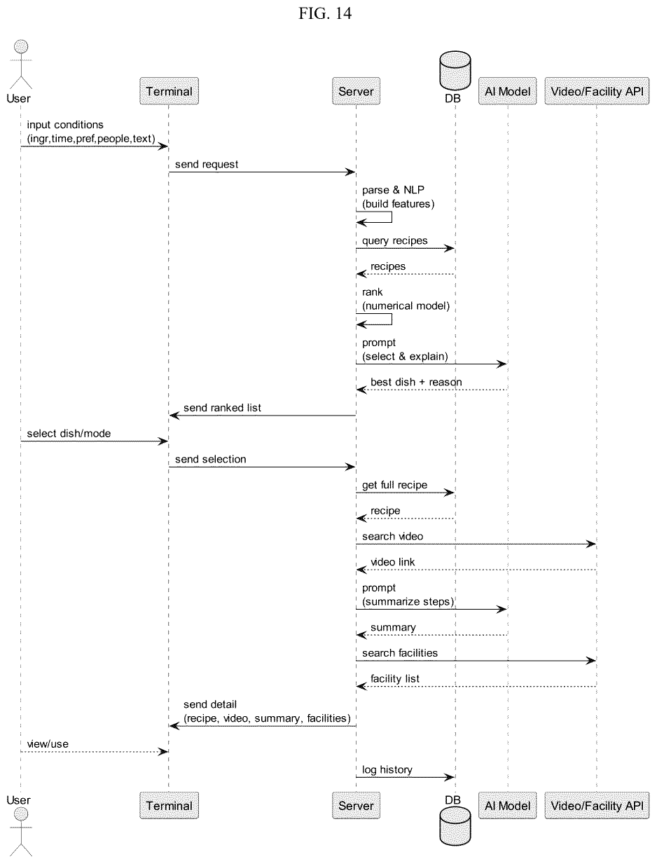

The following describes the processing flow using FIG. 14.

### Step 1:

User operates terminal to start an application for recipe support and ordering.

User views an input screen including fields for ingredients, required time, preference, number of persons, and a free-text box.

User inputs, as an example, “chicken, onion, tomato” into an ingredient field, “30 minutes” into a time field, “spicy” into a preference field, “2” into a number-of-persons field, and “I am tired today” into the free-text box.

Terminal receives these raw input values as UI events and aggregates them into an internal data structure.

Input: raw user keystrokes and UI selection events.

Output: a structured request object containing ingredients text, required time text, preference text, number-of-persons text, and free-text content.

### Step 2:

Terminal converts the structured request object into a normalized message for transmission. Terminal maps UI fields to keys such as “ingredients,” “time,” “preference,” “people,” and “free_text,” and encodes their values into a serialized format.

Terminal optionally performs simple validation (for example, checking that time is numeric) and converts “30 minutes” to the integer 30 and “2” to the integer 2.

Terminal sends the serialized message to server via a network interface using a communication protocol.

Input: structured request object from Step 1.

Output: a network message containing normalized user input data transmitted to server.

### Step 3:

Server receives the network message through a server-side communication module.

Server parses the message body, decodes the serialized data, and populates local variables for ingredients, required time, preference, number of persons, and free text.

Server logs the received data into a request log store for monitoring and debugging.

Input: network message from terminal.

Output: in-memory variables representing user input and a log record stored in a logging system.

### Step 4:

Server executes character-string analysis processing on the free-text field and other textual fields. Server tokenizes the free-text string “I am tired today” into tokens, assigns part-of-speech tags, and applies a lexicon or rule set to detect emotion-related terms such as “tired.” Server converts ingredient strings “chicken, onion, tomato” into canonical ingredient identifiers by matching tokens against an ingredient dictionary and lowercasing or trimming punctuation.

Input: raw text fields (ingredients text and free-text) from Step 3.

Output: canonical ingredient identifiers list, required time as a numeric value, preference category, number of persons as a numeric value, and an emotion keyword such as “fatigue.”

### Step 5:

Server constructs a feature vector representing the current session.

Server encodes canonical ingredients into a multi-hot vector, encodes preference type (for example, “spicy”) into a categorical vector, places required time and number of persons as numeric features, and encodes the emotion keyword into an emotion feature slot.

Server concatenates these elements into a fixed-length feature vector and stores it temporarily in main memory; server may also persist the feature vector into a user history table for later training.

Input: normalized symbols and numeric values from Step 4.

Output: a numerical feature vector representing the user's current request and state.

### Step 6:

Server searches a recipe database to obtain candidate dishes that satisfy basic constraints.

Server builds a database query using canonical ingredients and required time; for example, server requires that recipes contain at least one or more of the requested ingredients and do not exceed the requested cooking time.

Server executes the query against a relational database management system and retrieves multiple recipe records including fields such as recipe_id, name, required_time, ingredients_json, tags_json, and procedure_text.

Input: canonical ingredient identifiers and required time from Step 4.

Output: a list of candidate recipe records loaded into server memory.

### Step 7:

Server calculates feature values for each candidate dish.

Server computes, for each recipe, an ingredient-matching degree by comparing requested ingredients against the recipe's ingredient list, a preference-matching degree by comparing user preference against recipe tags, and a required-time parameter as a function of the difference between requested time and recipe time.

Server combines these values with the emotion feature and any available past-selection history parameters to form an input vector for a trained numerical analysis model per recipe.

Input: candidate recipe records from Step 6 and session feature vector from Step 5.

Output: per-recipe input vectors ready for evaluation by the numerical analysis model.

### Step 8:

Server applies a trained numerical analysis model to compute evaluation values for candidate dishes.

Server feeds each per-recipe input vector into the numerical model; the model performs matrix multiplications, bias additions, and non-linear activations to generate a scalar score for each candidate.

Server receives evaluation values and sorts candidates in descending order of score, thereby ranking dishes according to suitability for the user's current context and emotional state.

Input: per-recipe input vectors from Step 7.

Output: a ranked list of candidate recipes, each with an evaluation value.

### Step 9:

Server constructs a prompt sentence for a generative AI model to refine the top candidates and generate a human-readable explanation.

Server selects a subset of top-ranked recipes, extracts their names, and formats a textual description that embeds user conditions and emotion.

Server generates, as an example, the following prompt sentence:
“User conditions: ingredients=chicken, onion, tomato; required time=30 minutes; preference=spicy; people=2.

User emotion: tired.

Based on these conditions, select the best recipe from the following candidates and briefly explain why it suits the user's emotion:
1) Spicy Chicken Curry
2) Simple Chicken Tomato Stir-fry.”

Input: ranked candidate list and session feature data from Step 8.

Output: a prompt sentence string prepared for the generative AI model.

### Step 10:

Server submits the prompt sentence to a generative AI model interface.

Server sends the text of the prompt sentence to the model service via an application programming interface, receives a generated text output, and parses the output to extract a recommended recipe name and an explanation sentence.

Server associates the explanation sentence with the corresponding recipe entry in the ranked list as an annotation field such as reason_for_recommendation.

Input: prompt sentence from Step 9.

Output: an updated ranked candidate list including an explicit recommended dish and associated explanation text.

### Step 11:

Server transmits the ranked candidate list and explanation data to terminal.

Server serializes the list of recipes, evaluation scores, and explanation sentences into a response message and sends this message back through the network interface.

Terminal receives the message, deserializes the data, and constructs UI elements (for example, cards or list items) for each candidate dish.

Input: ranked and annotated candidate list from Step 10.

Output: structured response data at terminal for display, and an internal model of candidate dishes in terminal memory.

### Step 12:

Terminal displays the candidate dishes to user and collects a selection.

Terminal renders each candidate dish with name, approximate cooking time, and the explanation sentence generated by server.

User reviews the displayed options and taps on one recipe, such as “Spicy Chicken Curry.” Terminal captures the selection event and constructs a selection message containing the selected recipe_id and a mode indicator such as “cook_at_home” or “order_delivery.”

Input: structured candidate list from Step 11 and user interaction events.

Output: selection message including recipe identification and usage mode sent to server.

### Step 13:

Server receives the selection message and retrieves detailed recipe information.

Server reads the recipe_id from the message, issues a database query to fetch full details including ingredients_json, procedure_text, tags_json, nutrition_json, and any existing video link information.

Server loads the retrieved recipe record into memory for further processing, such as summarization and external video retrieval.

Input: selection message from Step 12.

Output: a detailed recipe object loaded in server memory.

### Step 14:

Server acquires or updates video link information for the selected recipe.

Server checks whether an existing video link is stored for the recipe; if not, or if marked stale, server constructs a query string based on the recipe name and tags, such as “Spicy Chicken Curry easy 30 minutes.”

Server sends this query to an external video distribution service interface, receives a list of candidate videos, and selects one based on title similarity, duration, and popularity metrics. Server generates a video link as reference information for the selected video and stores or updates it in the recipe record.

Input: recipe object from Step 13 and external video service response.

Output: recipe object extended with valid video link information.

### Step 15:

Server generates summarized procedure information using a generative AI model or a summarization process.

Server creates a summarization prompt sentence such as:

“Summarize the following detailed recipe instructions into 4 short, numbered steps that are easy to follow while cooking. Focus on the main actions and omit unnecessary detail. [full recipe text]”

Server sends the prompt sentence and the full procedure_text to the generative AI model interface, receives a summarized text output, and parses it into a sequence of short procedure sentences.

Input: full procedure_text from the recipe object obtained at Step 13.

Output: summarized procedure information consisting of short, ordered steps stored in association with the recipe.

### Step 16:

Server searches for food service facilities or delivery services that can provide the selected dish. Server uses recipe attributes and user location data to form a query, transmits this query to an external facility search device, and receives a list of candidate facilities with location and menu information.

Server filters these facilities by matching menu_keywords with the recipe name and tags, and optionally adjusts ranking using emotion-aware weights (for example, prioritizing comfort-oriented facilities when the user is tired).

Server builds order support information including facility identifiers, approximate distance, estimated delivery time, and pricing.

Input: recipe attributes from Step 13 and user location data, plus facility search response.

Output: an ordered list of facility entries and corresponding order support information.

### Step 17:

Server assembles a detailed response for terminal.

Server packages the recipe name, detailed ingredient list, summarized procedure information, video link, and order support information into a single response structure.

Server sends this structure to terminal over the network.

Terminal receives the response, parses it, and prepares a detailed recipe view and a list of facility options for presentation to user.

Input: recipe object with video link from Step 14, summarized procedure from Step 15, and order support information from Step 16.

Output: fully populated detail view data at terminal.

### Step 18:

Terminal displays the detailed recipe, video link, and order options.

Terminal shows the recipe title, ingredients, summarized steps, and a clickable video link or thumbnail.

Terminal presents order support information as selectable facility entries, each with additional details such as price and estimated time.

User reads the summarized steps, optionally plays the video, and may choose to send an order request.

Input: detailed view data from Step 17 and user interaction.

Output: visual and audio output to user, and potentially a new order message containing selected facility and order parameters sent to server.

### Step 19:

Server logs the interaction and updates user history for personalization.

Server records the current feature vector, selected recipe_id, emotion state, and any viewed video_id and order outcome into the history table.

Server updates aggregate preference features for the user, such as counters of selected dishes by emotion, and stores these aggregates for future sessions.

Input: feature vector from Step 5, selected recipe_id from Step 13, and interaction results from Steps 14-18.

Output: updated history records and updated preference statistics stored in the database, which will be used to generate future feature vectors and prompt sentences.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Moreover, although the processing by the data processing system 10 described above was executed by the specific processing unit 290 of the data processing device 12 or by the control unit 46A of the smart device 14, the processing may be executed by a specific processing unit 290 of the data processing device 12 and a control unit 46A of the smart device 14. Moreover, the specific processing unit 290 of the data processing device 12 acquires and collects information needed for processing from the smart device 14 or from an external device or the like, and the smart device 14 acquires and collects information needed for processing from the data processing device 12 or from an external device or the like.

For example, a collection unit is implemented by the control unit 46A of the smart device 14 and/or by the specific processing unit 290 of the data processing device 12. For example, an acquisition unit acquires number-of-steps data using the camera 42 and/or the communication I/F 44 of the smart device 14, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the output device 40 of the smart device 14 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the smart device 14.

### Second Exemplary Embodiment

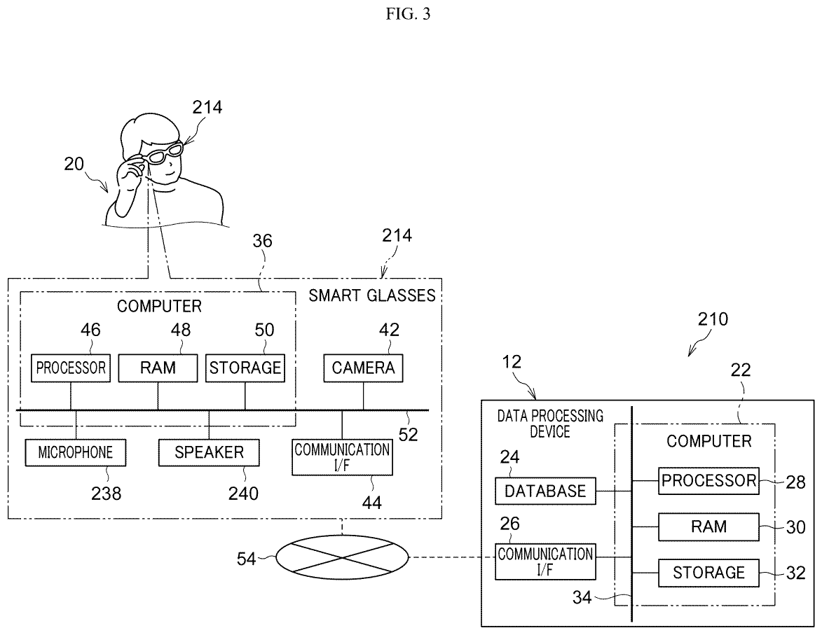

FIG. 3 illustrates an example of a configuration of a data processing system 210 according to a second exemplary embodiment.

As illustrated in FIG. 3, the data processing system 210 includes a data processing device 12 and smart glasses 214. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The smart glasses 214 include a computer 36, a microphone 238, a speaker 240, a camera 42, and a communication I/F 44. The computer 36 includes a processor 46, RAM 48, and storage 50. The processor 46, the RAM 48, and the storage 50 are connected to a bus 52. The microphone 238, the speaker 240, the camera 42, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the user 20 (for example, an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

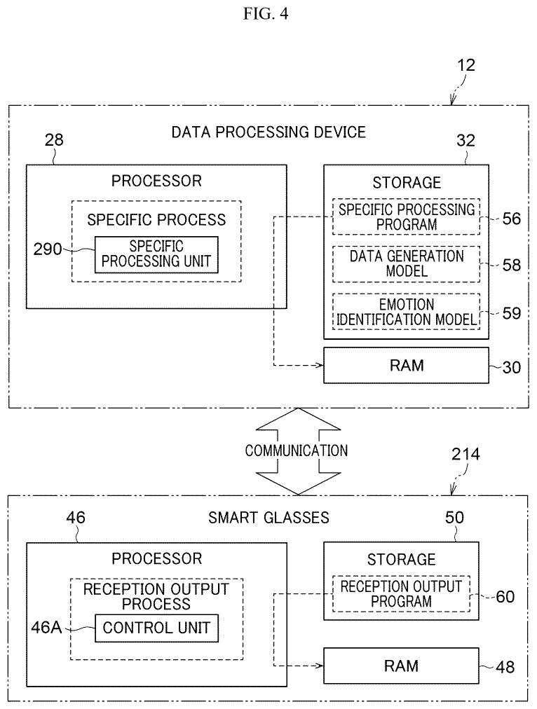

FIG. 4 illustrates an example of relevant functions of the data processing device 12 and the smart glasses 214. As illustrated in FIG. 4, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290. The specific processing unit 290 uses the emotion identification model 59 to estimate an emotion of a user, and is able to perform the specific processing using the user emotion. In an emotion estimation function (emotion identification function) that uses the emotion identification model 59, various estimations, predictions, and the like are performed related to emotions of the user, include estimating and predicting the emotion of the user, however, there is no limitation to such examples. Moreover, estimation and prediction of emotion also includes, for example, analyzing (parsing) emotions and the like.

Reception and output processing is performed by the processor 46 in the smart glasses 214. A reception and output program 60 is stored in the storage 50. The processor 46 reads the reception and output program 60 from the storage 50 and in the RAM 48 executes the read reception and output program 60. The reception and output processing is implemented by the processor 46 operating as the control unit 46A according to the reception and output program 60 executed in the RAM 48. Note that a configuration may be adopted in which the smart glasses 214 include a data generation model and an emotion identification model similar to the data generation model 58 and the emotion identification model 59, and processing similar to the specific processing unit 290 is performed using these models.

Next, description follows regarding the specific processing by the specific processing unit 290 of the data processing device 12. The units of the system described below are implemented by the data processing device 12 and the smart glasses 214. In the following description the data processing device 12 is called a “server”, and the smart glasses 214 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the smart glasses 214. The control unit 46A in the smart glasses 214 outputs the specific processing result to the speaker 240. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative Als such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the smart glasses 214, the processing may be executed by a specific processing unit 290 of the data processing device 12 and a control unit 46A of the smart glasses 214. Moreover, the specific processing unit 290 of the data processing device 12 acquires and collects information needed for processing from the smart glasses 214 or from an external device or the like, and the smart glasses 214 acquires and collects information needed for processing from the data processing device 12 or from an external device or the like.

For example, the collection unit is implemented by the control unit 46A of the smart glasses 214 and/or by the specific processing unit 290 of the data processing device 12. For example, an acquisition unit acquires number-of-steps data using the camera 42 and/or the communication I/F 44 of the smart glasses 214, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 of the smart glasses 214 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the smart glasses 214.

### Third Exemplary Embodiment

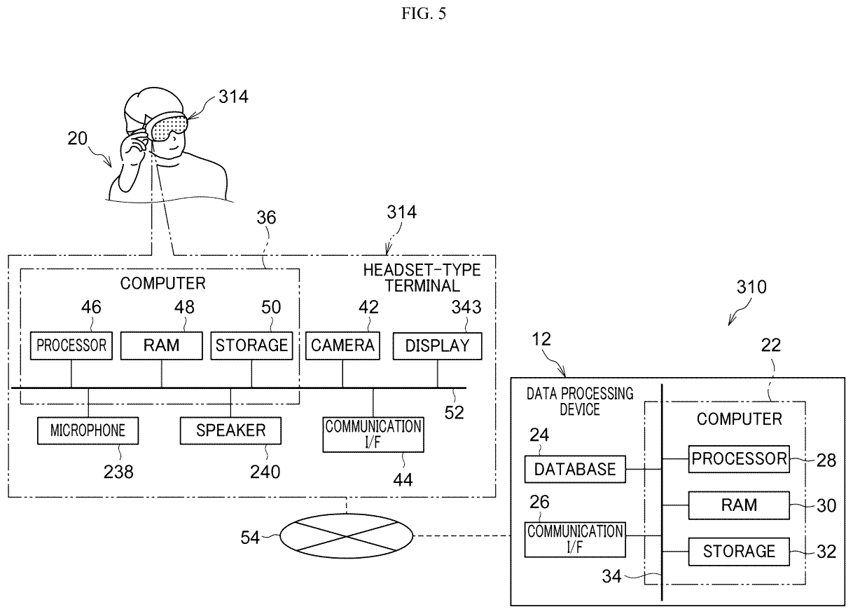

FIG. 5 illustrates an example of a configuration of a data processing system 310 according to a third exemplary embodiment.

As illustrated in FIG. 5, the data processing system 310 includes a data processing device 12 and a headset-type terminal 314. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The headset-type terminal 314 includes a computer 36, a microphone 238, a speaker 240, a camera 42, a communication I/F 44, and a display 343. The computer 36 includes a processor 46, RAM 48, and storage 50. The processor 46, the RAM 48, and the storage 50 are connected to a bus 52. The microphone 238, the speaker 240, the camera 42, the display 343, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the user 20 (for example, an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

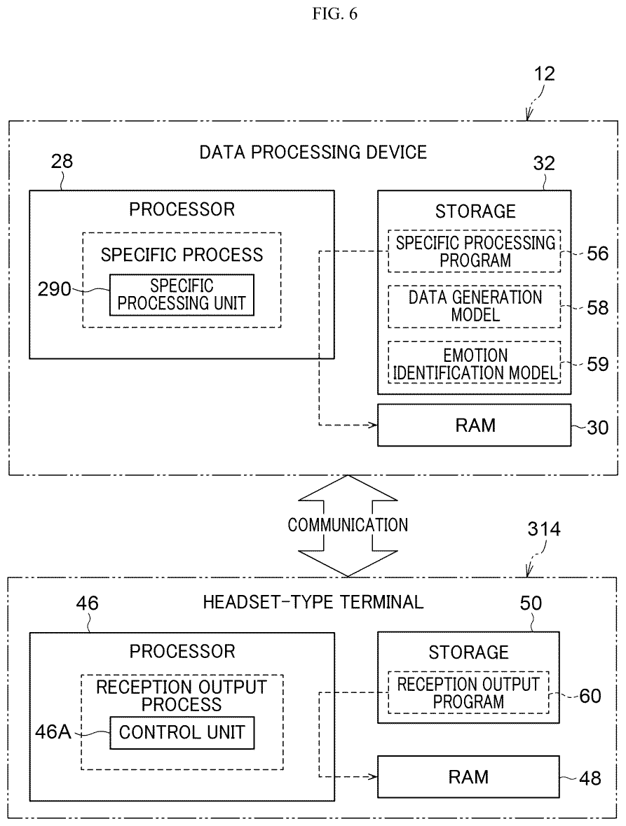

FIG. 6 illustrates an example of relevant functions of the data processing device 12 and the headset-type terminal 314. As illustrated in FIG. 6, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290.

Reception and output processing is performed by the processor 46 in the headset-type terminal 314. A reception and output program 60 is stored in the storage 50. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48.

Next, description follows regarding the specific processing by the specific processing unit 290 of the data processing device 12. The units of the system described below are implemented by the data processing device 12 and the headset-type terminal 314. In the following description the data processing device 12 is called a “server”, and the headset-type terminal 314 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the headset-type terminal 314. In the headset-type terminal 314, the control unit 46A outputs the result of the specific processing to the speaker 240 and the display 343. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the headset-type terminal 314, the processing may be executed by a specific processing unit 290 of the data processing device 12 and a control unit 46A of the headset-type terminal 314. Moreover, the specific processing unit 290 of the data processing device 12 acquires and collects information needed for processing from the headset-type terminal 314 or from an external device or the like, and the headset-type terminal 314 acquires and collects information needed for processing from the data processing device 12 or from an external device or the like.

For example, the collection unit is implemented by the control unit 46A of the headset-type terminal 314 and/or by the specific processing unit 290 of the data processing device 12. For example, an acquisition unit acquires number-of-steps data using the camera 42 and/or the communication I/F 44 of the headset-type terminal 314, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 and the display 343 of the headset-type terminal 314 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the headset-type terminal 314.

### Fourth Exemplary Embodiment

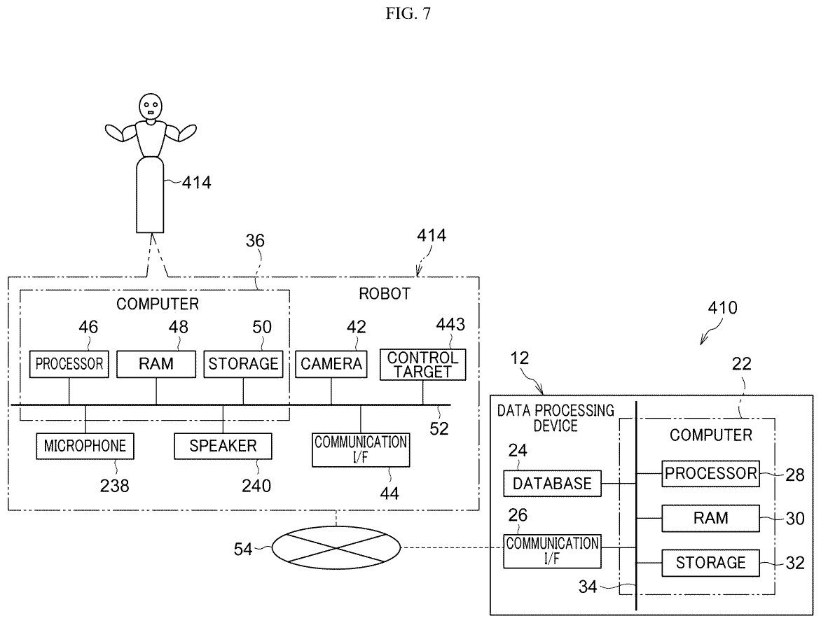

FIG. 7 illustrates an example of a configuration of a data processing system 410 according to a fourth exemplary embodiment

As illustrated in FIG. 7, the data processing system 410 includes a data processing device 12 and a robot 414. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The robot 414 includes a computer 36, a microphone 238, a speaker 240, a camera 42, a communication I/F 44, and a control target 443. The computer 36 includes a processor 46, RAM 48, and storage 50. The processor 46, the RAM 48, and the storage 50 are connected to a bus 52. The microphone 238, the speaker 240, the camera 42, the control target 443, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the robot 414 (for example, with an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

The control target 443 includes a display device, eye LEDs, and motors to drive arms, hands, feet, and the like. The posture and gesture of the robot 414 are controlled by controlling the motors of the arms, hands, feet, and the like. Part of an emotion of the robot 414 can be expressed by controlling these motors. Moreover, a facial expression of the robot 414 can be represented by controlling an illumination state of the eye LEDs of the robot 414.

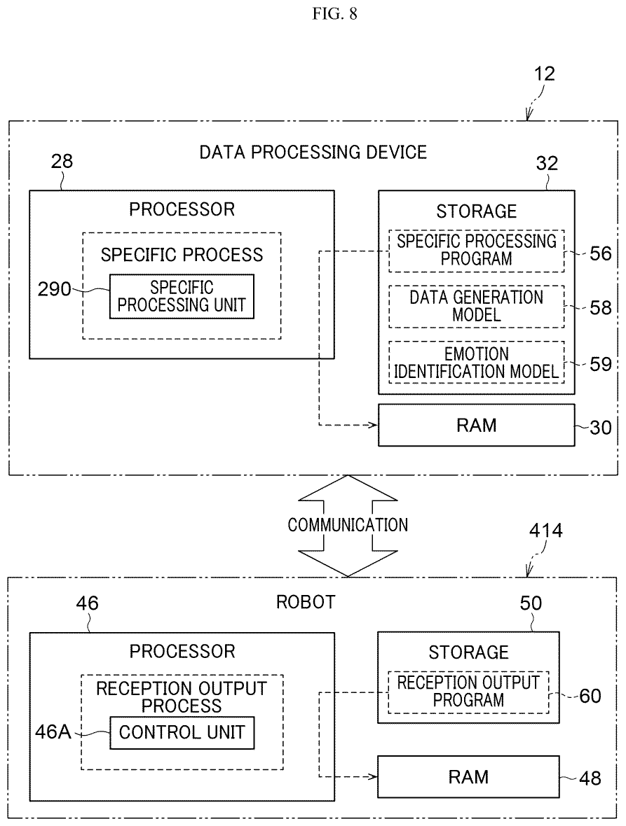

FIG. 8 illustrates an example of relevant functions of the data processing device 12 and the robot 414. As illustrated in FIG. 8, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290.

Reception and output processing is performed by the processor 46 in the robot 414. A reception and output program 60 is stored in the storage 50. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48.

Next, description follows regarding the specific processing by the specific processing unit 290 of the data processing device 12. The units of the system described below are implemented by the data processing device 12 and the robot 414. In the following description the data processing device 12 is called a “server”, and the robot 414 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the robot 414. In the robot 414, the control unit 46A outputs the result of the specific processing to the speaker 240 and the control target 443. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative Als such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the robot 414, the processing may be executed by a specific processing unit 290 of the data processing device 12 and a control unit 46A of the robot 414. Moreover, the specific processing unit 290 of the data processing device 12 acquires and collects information needed for processing from the robot 414 or from an external device or the like, and the robot 414 acquires and collects information needed for processing from the data processing device 12 or from an external device or the like.

For example, the collection unit is implemented by the control unit 46A of the robot 414 and/or by the specific processing unit 290 of the data processing device 12. For example, an acquisition unit acquires number-of-steps data using the camera 42 and/or the communication I/F 44 of the robot 414, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 and the control target 443 of the robot 414 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the robot 414.

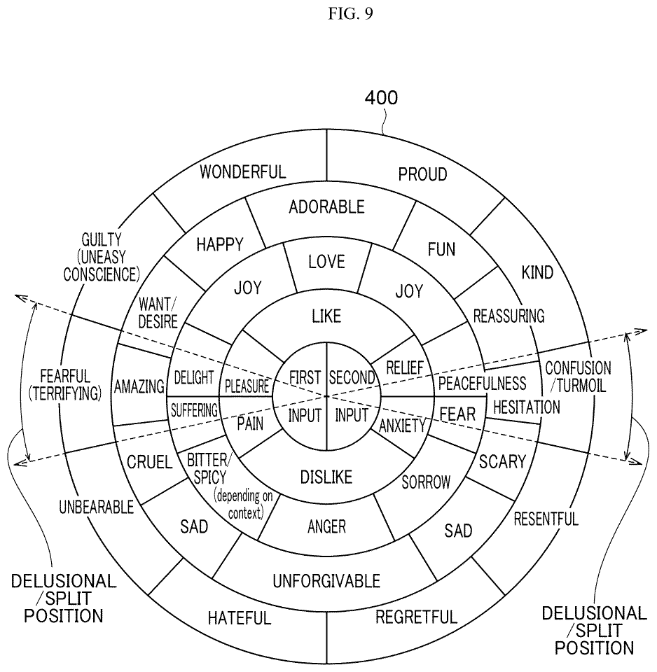

Note that the emotion identification model 59 serves as an emotion engine, and may decide the emotion of a user according to a specific mapping. Specifically, the emotion identification model 59 may decide the emotion of a user according to an emotion map (see FIG. 9) that is a specific mapping. Moreover, the emotion identification model 59 may also decide the emotion of the robot similarly, and the specific processing unit 290 may be configured so as to perform the specific processing using the emotion of the robot.

FIG. 9 is a diagram illustrating an emotion map 400 mapping plural emotions. In the emotion map 400, emotions are arranged in concentric circles that radiate out from the center. Primitive states of emotion are arranged nearer to the center of the concentric circles. Emotions expressing states and actions generated from states of mind are arranged further toward the outside of the concentric circles. Emotions are defined as including both affect and mental states. Emotions generated from reactions occurring in the brain are generally arranged at the left side of the concentric circles. Emotions induced by situational assessment are generally arranged at the right side of the concentric circles. Emotions generated from reactions occurring in the brain that are also emotions induced by situational assessment are generally arranged toward the top and toward the bottom of the concentric circles. Moreover, emotions of “euphoria” are arranged at the upper side of the concentric circles, and emotions of “dysphoria” are arranged at the lower side of the concentric circles. Plural emotions are accordingly mapped in this manner in the emotion map 400 based on a structure giving rise to emotions, and emotions that readily occur at the same time are mapped close to each other.

An example of such emotions is a distribution of emotions in the direction of 3 o'clock on the emotion map 400, generally around a boundary between relief and anxiety. Situational awareness dominates over internal sensations in the right half of the emotion map 400, with an impression of calm.

The inside of the emotion map 400 represents feelings, and the outside of the emotion map 400 represents actions, and so emotions further toward the outside of the emotion map 400 are more visible (are expressed by actions).

Human emotions are based on various balances, such as posture and blood sugar value balances, with a state of dysphoria being exhibited when these balances are far from ideal and a state of euphoria being exhibited when these balances are near to ideal. Even in a robot, a car, a motorbike, or the like, emotions can be thought of as being based on various balances such as orientation and remaining battery balances, with a state called dysphoria being exhibited when these balances are far from ideal and a state called euphoria being exhibited when these balances are near to ideal. An emotion map may, for example, be generated based on the emotion map of Dr. Mitsuyoshi (PhD Dissertation https://ci.nii.ac.jp/naid/500000375379: “Research on the phonetic recognition of feelings and a system for emotional physiological brain signal analysis”, Tokushima University). Emotions belonging to an area called “reaction” where feeling dominates are arranged in the left half of the emotion map. Moreover, emotions belonging to an area called “situation” where situational awareness dominates are arranged in the right half of the emotion map.

There are two types of emotion that facilitate leaning in an emotion map. One is an emotion in the vicinity of the center of negative “penitence” and “reflection” on the situational side. In other words, sometimes a negative “emotion” such as “I don't want to feel this way ever again” and “I don't want to be chided again” is experienced in a robot. Another is a positive emotion in the area of “desire” on the reaction side. In other words, there are times when a positive feeling such as “desire more” and “want to know more” is experienced.

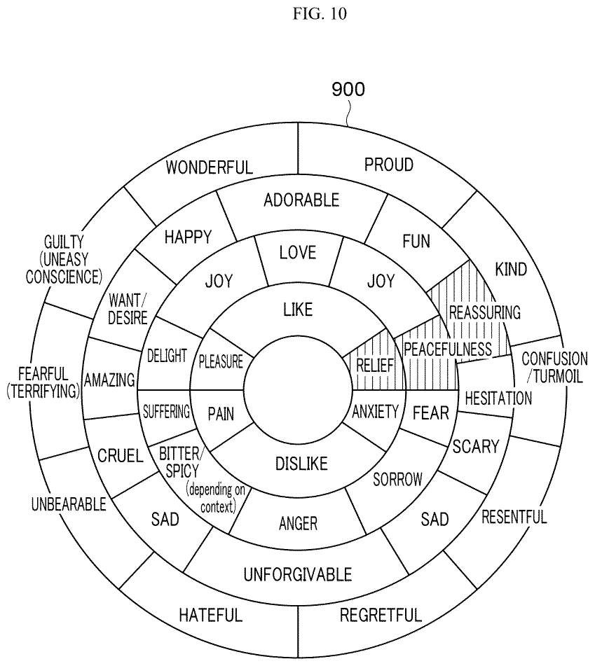

In the emotion identification model 59, user input is input to a pre-trained neural network, and emotion values indicating emotions shown on the emotion map 400 are acquired and the emotions of the user are decided. This neural network is pre-trained based on plural training data sets that each combine a user input with an emotion value indicating an emotion shown on the emotion map 400. The neural network is also trained such that emotions arranged close to each other have values that are close to each other, as in an emotion map 900 illustrated in FIG. 10. In FIG. 10 the plural emotions of “relief”, “peaceful”, and “reassured” are indicated as an example of close emotion values.

Although the system according to the present disclosure has been described mainly as functions of the data processing device 12, the system according to the present disclosure is not limited to being implemented in a server. The system according to the present disclosure may be implemented as a general information processing system. The present disclosure may, for example, be implemented by a software program operating on a personal computer, and may be implemented by an application operating on a smartphone or the like. The method according to the present disclosure may also be supplied to a user in the form of Software as a Service (Saas).

Although in the exemplary embodiments described above examples are given of embodiments in which the specific processing is performed by a single computer 22, technology disclosed herein is not limited thereto, and distributed processing may be performed for the specific processing, with the specific processing distributed across plural computers including the computer 22. For example, the data generation model 58 may be provided in a device external to the data processing device 12, such that data generation in response to input data is performed in the external device.

Although in the exemplary embodiments described above examples are described of embodiments in which the specific processing program 56 is stored in the storage 32, the technology disclosed herein is not limited thereto. For example, the specific processing program 56 may be stored on a portable, non-transitory, computer readable, storage medium, such as universal serial bus (USB) memory or the like. The specific processing program 56 stored on the non-transitory storage medium is then installed on the computer 22 of the data processing device

### 12. The Processor 28 then Executes the Specific Processing According to the Specific Processing Program 56

Moreover, the specific processing program 56 may be stored on a storage device, such as a server connected to the data processing device 12 over the network 54, with the specific processing program 56 then being downloaded in response to a request from the data processing device 12 and installed on the computer 22.

Note that there is no need to store the entire specific processing program 56 on the storage device, such as a server connected to the data processing device 12 over the network 54, or to store the entire specific processing program 56 on the storage 32, and part of the specific processing program 56 may be stored thereon.

Hardware resources for executing the specific processing may use various processors as listed below. Examples of processors include, for example, a CPU that is a general-purpose processor that functions as a hardware resource to execute the specific processing by executing software, namely a program. Moreover, the processor may, for example, be a dedicated electronic circuit that is a processor having a circuit configuration custom designed for executing the specific processing, such as a field-programmable gate array (FPGA), a programmable logic device (PLD), or an application specific integrated circuit (ASIC). Memory is inbuilt or connected to each of these processors, and the specific processing is executed by each of these processors using the memory.

The hardware resource that executes the specific processing may be configured from one of these various processors, or may be configured from a combination of two or more processors of the same or different type (for example, a combination of plural FPGAs, or a combination of a CPU and a FPGA). The hardware resource executing the specific processing may be a single processor.

Examples of configurations of a single processor include, firstly, a configuration of a single processor resulting from combining one or more CPU and software, in an embodiment in which this processor functions as the hardware resource for executing the specific processing. Secondly, as typified by a System-on-chip (SOC) or the like, there is also an embodiment that uses a processor realized by a single IC chip to function as an overall system including plural hardware resources for executing the specific processing. Adopting such an approach means that the specific processing is realized using one or more of the various processors described above as hardware resource.

Furthermore, more specifically, an electrical circuit that combines circuit elements such as semiconductor elements or the like may be employed as a hardware structure of these various processors. The specific processing is merely an example thereof. This means that obviously redundant steps may be omitted, new steps may be added, and the processing sequence may be swapped around within a range not departing from the spirit of the present disclosure.

The described content and drawing content illustrated above are a detailed description of parts according to the present disclosure, and are merely examples of the present disclosure. For example, description related to the above configuration, function, operation, and advantageous effects is a description related to examples of the configuration, function, operation, and advantageous effects of parts according to the present disclosure. This means that obviously redundant parts may be eliminated, new elements may be added, and switching around may be performed on the described content and drawing content illustrated above within a range not departing from the spirit of the present disclosure. Moreover, to avoid misunderstanding and to facilitate understanding of parts according to the present disclosure, description related to common knowledge in the art and the like not particularly needing description to enable implementation of the present disclosure is omitted in the described content and drawing content illustrated as described above.

All publications, patent applications and technical standards mentioned in the present specification are incorporated by reference in the present specification to the same extent as if each individual publication, patent application, or technical standard was specifically and individually indicated to be incorporated by reference.

Note that, regarding the above description, the following supplementary notes are further disclosed.

### Example 1

### (Supplementary 1)

A system comprising a processor, and an input/output device,
wherein the processor is configured to
acquire information regarding ingredients, required time, preferences, and number of servings from a user via the input/output device;
convert audio information acquired from the input/output device into character information by speech recognition processing, convert image information acquired from the input/output device into ingredient information by image recognition processing, and integrate the character information, the ingredient information, and character information directly input by the user to generate integrated text information representing a request of the user;
execute natural language processing on the integrated text information to extract structured condition information including the ingredients, the required time, the preferences, and the number of servings, and normalize the structured condition information to generate standardized condition information;
generate a prompt sentence in natural language including the standardized condition information by embedding the standardized condition information into a predetermined sentence template, the prompt sentence being configured to be input to a generative AI model;
input the prompt sentence to the generative AI model disposed externally or internally with respect to the system, and obtain, from the generative AI model, candidate recipe information for a dish, the candidate recipe information including a dish name, a list of materials, and cooking procedures;
analyze the candidate recipe information and convert the candidate recipe information into a recipe data structure in a machine-readable format including the dish name, material items, and a plurality of step information items representing the cooking procedures;
shorten the cooking procedures included in the recipe data structure by rule-based processing or summarization processing using the generative AI model, and generate summarized cooking method information;
search for or generate, based on the dish name and the ingredient information, a visual information link indicating a reference destination for visual information that visually presents a cooking method of the dish;
transmit the candidate recipe information, the summarized cooking method information, and the visual information link to the input/output device, and cause the input/output device to display the candidate recipe information, the summarized cooking method information, and the visual information link; and
search, based on the dish selected by the user, a food providing facility or a delivery providing service that provides the dish, and provide order support information via the input/output device.

### (Supplementary 2)

The system according to supplementary 1,
wherein the processor is configured to
include instruction information based on an emotional state of the user in the prompt sentence, cause the generative AI model to perform emotion analysis, and perform control to select or modify a plurality of pieces of the candidate recipe information based on an emotion analysis result obtained from the generative AI model and the standardized condition information.

### (Supplementary 3)

The system according to supplementary 1,
wherein the processor is configured to
present the recipe data structure, the summarized cooking method information, and the visual information link, via the input/output device, as information for allowing the user to cook the dish by the user, and generate, on the input/output device, an operation screen for performing an order operation to the food providing facility or the delivery providing service that provides the same or a similar dish.

### Application Example 1

### (Supplementary 1)

A system comprising a processor,
wherein the processor is configured to
receive, via an input/output device, information including ingredient information, required time information, preference information, number-of-persons information, and input-format information that are acquired from a user terminal,
when the input-format information indicates voice input, transmit an audio signal received from the user terminal to a speech recognition processing device, obtain character string data converted from the audio signal by the speech recognition processing device, and generate structured data by associating the character string data with respective items of the ingredient information, the required time information, the preference information, and the number-of-persons information,
execute, based on the structured data, search processing and aggregation processing on a cooking information set stored in an information storage device, extract a plurality of candidate cooking information items that match or approximate conditions of the ingredient information, the required time information, the preference information, and the number-of-persons information, and generate cooking candidate information by summarizing the plurality of candidate cooking information items,
generate a prompt sentence to be input to a generative AI model, the prompt sentence being generated based on the structured data and the cooking candidate information and including an output format and evaluation indices for the cooking candidate information so as to define a structure and content of a candidate cooking proposal result output by the generative AI model in response to the prompt sentence,
input the prompt sentence to the generative AI model, obtain the candidate cooking proposal result from the generative AI model, analyze the candidate cooking proposal result, and generate presentation data including a plurality of candidate cookings and priority information, based on the structured data and the candidate cooking proposal result, for presentation to a user, specify a cooking selected from among the plurality of candidate cookings based on selection information received from the user terminal, search the information storage device or an external information providing device based on identification information associated with the specified cooking, extract at least one food-providing facility or delivery service capable of providing the specified cooking, and generate order information for an order process for the at least one food-providing facility or delivery service, and
acquire cooking procedure information corresponding to the specified cooking from the information storage device, generate video link information including video identification information obtainable via a video providing device based on the cooking procedure information, generate a summarization prompt sentence for the generative AI model using the cooking procedure information as input information, obtain summarized cooking procedure information from the generative AI model based on the summarization prompt sentence, and provide the summarized cooking procedure information to the user terminal.

### (Supplementary 2)

The system according to supplementary 1,
wherein the processor is configured to
include, in the prompt sentence input to the generative AI model, item definitions for causing the generative AI model to output the cooking candidate information in a predetermined data structure and an identification-information item for causing the generative AI model to identify an optimal candidate cooking, analyze the candidate cooking proposal result output from the generative AI model based on the item definitions and the identification-information item, and optimize the candidate cooking proposal result in accordance with user preferences and conditions included in the structured data so as to determine contents and priorities of candidate cookings to be presented to the user.

### (Supplementary 3)

The system according to supplementary 1,
wherein the processor is configured to
perform interface processing in which, in response to a request from the user terminal, the processor transmits the video link information and the summarized cooking procedure information corresponding to the specified cooking to the user terminal, generates and transmits order request data to an external order processing device based on the order information, acquires order confirmation information as a result of an order process performed by the external order processing device, and converts the order confirmation information into a format presentable by the user terminal.

### Example 2

### (Supplementary 1)

A system comprising a processor,
wherein the processor is configured to
receive, via an interface including a display device and an input device, condition information expressed in natural language from a user, the condition information including ingredient information, time-condition information, preference information, and number-of-persons information,
analyze the received condition information by using a natural language processing technique including string processing and morphological analysis, extract keywords indicating ingredient conditions, time conditions, number-of-persons conditions, and preference conditions from the condition information, and normalize the extracted keywords as structured data,
search, based on the structured data, a data set stored in a storage device and including cooking information, by using a query language, and extract, as candidate cooking information, a plurality of cooking information records that satisfy the condition information,
numerically convert, for each piece of the candidate cooking information, attribute information including ingredient-match information, time-condition match information, preference-condition match information, provision-history information, and evaluation information into feature values, calculate a suitability score for each piece of the candidate cooking information by using a supervised learning algorithm including an ensemble decision-tree model, and select, based on the suitability scores, optimum cooking information,
generate, based on the optimum cooking information and the condition information, a prompt sentence for input to a generative AI model by using a template process or a text-generation process, and transmit the prompt sentence to the generative AI model,
analyze response text received from the generative AI model, combine the response text with the optimum cooking information, edit the combined information as proposal information including recipe information, cooking-procedure information, variation information, and cooking-advice information, and present the proposal information to the user via the display device, and acquire, via the interface, re-input information or condition-change information from the user, and re-execute the analysis, search, selection, prompt-sentence generation, and cooperation with the generative AI model based on the re-input information or the condition-change information so as to update the proposal information.

### (Supplementary 2)

The system according to supplementary 1,
wherein the processor is configured to additionally generate, for the generative AI model, a prompt sentence for analyzing an emotional state related to the optimum cooking information, acquire the emotional state from the generative AI model, correct the suitability scores of the candidate cooking information based on the emotional state, and select cooking information that more closely matches an emotional tendency and a preference tendency of the user.

### (Supplementary 3)

The system according to supplementary 1,
wherein the processor is configured to generate, based on the optimum cooking information, identification information for video content indicating a cooking method and shortened cooking-procedure information, and provide, on the display device, an interface for executing an order process to a provision facility or a delivery service corresponding to the optimum cooking information.

### Application Example 2

### (Supplementary 1)

A system comprising a processor,
wherein the processor is configured to
acquire, via an information input/output device, information including ingredient information, required time information, preference information, number-of-persons information, and free description information from a user, and generate structured data corresponding to the ingredient information, the required time information, the preference information, and the number-of-persons information, and emotion-related terms from the free description information by executing character-string analysis processing,
generate a prompt sentence for a generative AI model on the basis of the free description information and the structured data, and input the prompt sentence to the generative AI model so as to cause the generative AI model to output an emotion analysis result including an emotional state of the user and cooking candidate information, and generate, as presentation data, a plurality of candidate dishes on the basis of the emotion analysis result and the structured data,
calculate feature values for each of the plurality of candidate dishes, the feature values including at least a required-time parameter, an ingredient-matching degree, a preference-matching degree, a past-selection-history parameter, and an emotion parameter based on the emotion analysis result, calculate an evaluation value for each candidate dish by using a trained numerical analysis model, and rank the candidate dishes on the basis of the evaluation values,
transmit the ranked candidate dishes to the information input/output device, cause the information input/output device to display a list of the candidate dishes, and acquire dish identification information of a dish selected by the user from the list,
search a storage device on the basis of the selected dish identification information to obtain cooking procedure information corresponding to the selected dish, transmit a search request to an external information providing device connected to a video distribution service, obtain reference information of a video showing a cooking procedure of the selected dish from the video distribution service, and generate video link information as the reference information, input the cooking procedure information to the generative AI model or to a character-string summarization process and generate, from the cooking procedure information, summarized procedure information comprising a sequence of short procedure sentences as a summarized cooking procedure,
search, on the basis of at least location information and dish attribute information, a facility information storage device or an external facility search device to specify a food service facility or a delivery service corresponding to the selected dish, and generate order support information for enabling an order operation to the specified facility or service,
transmit the video link information, the summarized procedure information, and the order support information to the information input/output device so as to cause the information input/output device to output the video link information, the summarized procedure information, and the order support information by at least one of display output and audio output, and
store, as history information, at least one of an input history, a selection history, a viewing history, and the emotion analysis result of the user, and perform personalization processing to update at least one of the prompt sentence and generation conditions of the plurality of candidate dishes on the basis of the history information.

### (Supplementary 2)

The system according to supplementary 1,
wherein the processor is configured to
configure the prompt sentence as a natural-language description including at least a preference feature based on user input conditions and the history information, the emotion analysis result, and attribute information regarding the plurality of candidate dishes, acquire, from the generative AI model, identification of a highly recommended dish among the plurality of candidate dishes and an explanation sentence describing a reason for recommendation, and add the explanation sentence to presentation data of the candidate dishes to be output to the information input/output device.

### (Supplementary 3)

The system according to supplementary 1,
wherein the processor is configured to
change a weight of at least one of emotional-response categories including a simple-cooking category, a celebratory-cooking category, and a calming-cooking category, on the basis of the emotion analysis result, reflect the weight of the emotional-response category in the feature values to be input to at least one of the trained numerical analysis model and the generative AI model, and thereby optimize at least one of the plurality of candidate dishes, the video link information, and the order support information in accordance with an emotional state of the user.

What is claimed is:

1. A system comprising:
circuitry configured to:
receive, via a communication interface coupled to a packet-switched network, audio information and image information from a terminal device, apply speech recognition processing to the audio information to produce first character information, apply image recognition processing to the image information to produce item identification data, and integrate the first character information, the item identification data, and directly input character information to produce integrated text information;
execute natural language processing on the integrated text information to extract structured condition information comprising item data, time constraint data, preference data, and quantity data, and normalize the structured condition information to produce standardized condition information;
generate a prompt sentence in natural language by embedding the standardized condition information into a predetermined sentence template and input the prompt sentence to a generative neural network model to obtain candidate output information comprising an output name, a list of materials, and a plurality of procedure steps;
convert the candidate output information into a structured data object comprising the output name, material item records, and step information records, and apply rule-based processing or summarization processing using the generative neural network model to the step information records to produce summarized procedure information;
search for, based on the output name and the item identification data, a visual information reference link indicating a reference destination for visual information that presents a procedure method; and
transmit the candidate output information, the summarized procedure information, and the visual information reference link to the terminal device, and transmit a request to an external data service via the communication interface to obtain provider information based on the output name selected by a user and provide order support information to the terminal device.

2. The system of claim 1, wherein the speech recognition processing applies a neural network-based automatic speech recognition model that maps acoustic feature vectors extracted from the audio information to text token sequences using beam search decoding to produce the first character information.

3. The system of claim 2, wherein the acoustic feature vectors comprise Mel-frequency cepstral coefficients computed per audio frame, and the first character information includes associated confidence scores per recognized token.

4. The system of claim 3, wherein the image recognition processing applies a convolutional neural network model to the image information to produce object classification labels with associated confidence scores, and the circuitry is configured to filter object classification labels below a confidence threshold before including them in the item identification data.

5. The system of claim 4, wherein the circuitry is configured to integrate the first character information, the item identification data, and directly input character information by concatenating the sources in a unified text representation with source-type annotations distinguishing speech-derived tokens, vision-derived tokens, and directly entered tokens.

6. The system of claim 1, wherein the natural language processing applied to the integrated text information applies named entity recognition to identify item names, numeric extraction to identify quantity values and time values, and sentiment classification to identify preference polarity labels.

7. The system of claim 6, wherein the circuitry is configured to normalize the structured condition information by mapping extracted item names to canonical identifiers using a lexicon stored in a storage device and converting time and quantity values to standardized unit representations.

8. The system of claim 7, wherein the circuitry is configured to generate the prompt sentence by selecting the predetermined sentence template from a plurality of templates stored in the storage device based on the quantity data and the time constraint data, and substituting standardized field values into template placeholders.

9. The system of claim 1, wherein the circuitry is configured to convert the candidate output information into the structured data object by parsing the output of the generative neural network model using pattern matching to delimit the output name, the material item records, and the step information records as discrete fields.

10. The system of claim 9, wherein the rule-based processing applied to the step information records identifies and removes redundant steps by detecting repeated action tokens across consecutive step records, and the summarization processing condenses remaining steps by re-inputting step text to the generative neural network model with a maximum token length constraint.

11. The system of claim 1, wherein searching for the visual information reference link comprises constructing a query string from the output name and the item identification data and querying a visual content index stored in a storage device or accessible via the communication interface.

12. The system of claim 1, wherein the request to the external data service comprises a query encoding the output name and a location parameter derived from user profile data stored in a storage device, and the circuitry is configured to receive provider records comprising provider names, availability indicators, and delivery time estimates as the provider information.

13. The system of claim 12, wherein the circuitry is configured to rank the provider records by a composite score computed from availability indicator values and delivery time estimates, and transmit the ranked provider records together with the order support information to the terminal device.

14. The system of claim 13, wherein the circuitry is configured to receive a user selection of a provider record from the terminal device and generate an order transmission message comprising item identification data derived from the structured data object and transmit the order transmission message to the selected provider via the communication interface.

15. The system of claim 1, wherein the circuitry is configured to acquire emotion state data from the terminal device by applying an emotion classification model to audio features or facial image features, and append an emotion parameter to the standardized condition information used to select the sentence template.

16. The system of claim 15, wherein the circuitry is configured to modify the prompt sentence by adding a tone instruction section derived from the emotion state data, conditioning the generative neural network model to produce output having a style aligned with the detected emotion state.

17. The system of claim 1, wherein the circuitry is configured to store the structured data object, the standardized condition information, and the user selection as historical records in a storage device, and use the historical records to refine the plurality of sentence templates by computing template performance metrics from user interaction feedback.

18. A system comprising:
circuitry configured to:
receive, via a communication interface coupled to a packet-switched network, audio information and image information from a terminal device, apply speech recognition processing using a neural network-based automatic speech recognition model with beam search decoding to produce first character information, apply a convolutional neural network model to the image information to produce item identification data with per-label confidence scores above a confidence threshold, and integrate the first character information, the item identification data, and directly input character information with source-type annotations;
apply named entity recognition and numeric extraction to the integrated text information to extract item data, time constraint data, preference data, and quantity data and normalize the extracted data to produce standardized condition information;
select a sentence template from a plurality of templates stored in a storage device based on the quantity data and the time constraint data, generate a prompt sentence by substituting standardized field values into template placeholders, and input the prompt sentence to a generative neural network model to produce candidate output information comprising an output name, material item records, and step information records;
apply pattern matching to parse the candidate output information into a structured data object and generate summarized procedure information by applying token-length-constrained summarization to the step information records;
search for a visual information reference link using a query constructed from the output name and the item identification data; and
transmit the candidate output information, the summarized procedure information, and the visual information reference link to the terminal device and transmit a request to an external data service comprising the output name and a location parameter to obtain and transmit ranked provider records to the terminal device as order support information.

19. The system of claim 18, wherein the circuitry is configured to receive a user selection of a provider record, generate an order transmission message comprising item identification data from the structured data object, and transmit the order transmission message to the selected provider via the communication interface.

20. A method comprising:
receiving, via a communication interface coupled to a packet-switched network, audio information and image information from a terminal device, applying speech recognition processing to the audio information to produce first character information, applying image recognition processing to the image information to produce item identification data, and integrating the first character information, the item identification data, and directly input character information to produce integrated text information;
executing natural language processing on the integrated text information to extract and normalize structured condition information;
generating a prompt sentence by embedding the standardized condition information into a predetermined sentence template and inputting the prompt sentence to a generative neural network model to obtain candidate output information;
converting the candidate output information into a structured data object and generating summarized procedure information; and
transmitting the candidate output information, the summarized procedure information, and a visual information reference link to the terminal device and transmitting a request to an external data service to obtain provider information and provide order support information to the terminal device.
